(19) United States
(12) Patent Application Publication
(10) Pub. No.: US 2021/0166322 A1
(43) Pub. Date: Jun. 3, 2021

(54) DYNAMICALLY RECONFIGURABLE INSURANCE PRODUCT

(71) Applicant: State Farm Mutual Automobile Insurance Company, Bloomington, IL (US)

(72) Inventors: Gregory D. Allen, El Paso, IL (US); Sajay Sadasivan, Normal, IL (US)

(73) Assignee: State Farm Mutual Automobile Insurance Company, Bloomington, IL (US)

(21) Appl. No.: 15/172,973

(22) Filed: Jun. 3, 2016

Related U.S. Application Data
(60) Provisional application No. 62/175,076, filed on Jun. 12, 2015.
(60) Provisional application No. 62/218,256, filed on Sep. 14, 2015.
(60) Provisional application No. 62/237,875, filed on Oct. 6, 2015.
(60) Provisional application No. 62/270,099, filed on Dec. 21, 2015.
(60) Provisional application No. 62/292,497, filed on Feb. 8, 2016.
(60) Provisional application No. 62/307,221, filed on Mar. 11, 2016.

(51) Int. Cl. G06Q 40/08

(52) U.S. Cl. CPC G06Q 40/08

(57) ABSTRACT

A dynamically reconfigurable insurance product, system, and computer-implemented method may, with customer permission or consent, collect customer data; analyze the customer data to determine life events, and customer location and activities; and dynamically adjust the insurance product in real-time or substantially real-time. The dynamically reconfigurable insurance product may include several types of insurance, such as auto, home, life, personal articles, etc. From the data collected, risk levels associated with the insured, their family, and/or personal belongings may be adjusted. Based upon the risk levels determined, different types of the insurance within the insurance product may be updated, or new types of insurance may be added to the insurance product. For instance, based upon a marriage or birth of a child, life insurance coverage may be added or increased. The customer may then be notified of the changes, or proposed changes, and approve or reject the changes to the insurance product.

### RELATED APPLICATIONS

The current patent application is a non-provisional patent application which claims priority benefit to the following identically-titled U.S. Provisional Applications: Ser. No. 62/175076, filed Jun. 12, 2015; Ser. No. 62/218256, filed Sep. 14, 2015; Ser. No. 62/237875, filed Oct. 6, 2015; Ser. No. 62/270099, filed Dec. 21, 2015; Ser. No. 62/292497, filed Feb. 8, 2016; and Ser. No. 62/307221, filed Mar. 11, 2016. The listed earlier-filed provisional applications are hereby incorporated by reference in their entireties into the current patent application.

### FIELD OF THE INVENTION

The present embodiments relate generally to insurance. More particularly, the present embodiments relate to performing certain actions, and/or adjusting insurance policies, or dynamic insurance or financial products, based upon (i) customer-related data indicative of risk, or lack thereof; (ii) changing insurance or financial needs; and/or (iii) life events, customer activity, or life circumstances.

### BACKGROUND

Conventional insurance techniques and policies may not provide adequate insurance coverage to insurance customers. Insurance policies may be based upon inadequate or aged customer information. Additionally, customers may not have the time or interest in reviewing insurance options and then selecting an appropriate insurance policy. Conventional insurance techniques may also suffer from the lack of incentivizing the preferred types of risk averse behaviors; failure to properly and timely identify risks associated with an individual and/or their insured properties; inefficient or ineffective customer communications; and/or other drawbacks.

The present embodiments may overcome these and/or other deficiencies.

### BRIEF SUMMARY

The present embodiments may disclose systems and methods that may provide a dynamically reconfigurable insurance product. The dynamically reconfigurable insurance product may include several types of insurance, such as auto, homeowners, life, renters, personal articles, burial, pet, and/or other types of insurance, and/or may include several different coverages, deductibles, and/or limits. A signal premium, rate, or discount for the dynamic insurance product may be periodically charged to the customer, and/or the cost of additional coverages may be dynamically charged to the customer, or the savings on less coverage may be dynamically refunded or otherwise returned or credited to the customer.

Further, the present embodiments may relate to the intersection of insurance and data collection via electronic devices. Customer-related information and /or other data, such as GPS (Global Positioning System) data, may be gathered with customer permission via one or more sources, including mobile devices (e.g., smart phones, smart glasses, smart watches, smart wearable devices, smart contact lenses, and/or other devices capable of wireless communication or data transmission); smart vehicles; smart vehicle or smart home mounted sensors; third party sensors or sources of data (e.g., other vehicles, public transportation systems, government entities, and/or the internet); social media or social websites; and/or other sources of information. In some aspects, the customer data may include customer or vehicle location data, and/or even conventional telematics data. With customer consent, the customer data may be analyzed to determine that a life event has happened or is about to happen; that a risk level for the customer or their properties has changed; and/or that customer needs have changed. Based upon computer analysis of the customer data, the dynamically reconfigurable insurance product may be adjusted, such as to provide more appropriate insurance coverage to the customer.

In one aspect, a computer-implemented method of providing and adjusting a dynamically reconfigurable insurance product covering multiple types of insurance to an insured may be provided. The method may include, with customer permission, (1) receiving, at or via one or more processors (such as a remote server or processor associated with an insurance provider), customer-related data; (2) determining, at or via the one or more processors, a life event (or other customer activity), and/or type thereof, from computer analysis of the customer-related data; (3) adjusting, at or via the one or more processors, the dynamically reconfigurable insurance product (and/or an associated dynamic insurance product premium or discount) based upon, at least in part, the computer analysis of the customer-related data and/or life event (or other customer activity), and/or type thereof, determined; (4) generating, at or via the one or more processors, a notification of the adjustment (or recommended adjustment) to the dynamically reconfigurable insurance product, such as a wireless communication or data transmission notification; (5) transmitting, via the one or more processors or associated transceiver (such as via wireless communication or data transmission), the notification to a mobile device or other computing device of the insured for the insured's review, approval, and/or rejection; (6) receiving, via or at the one or more processors or associated transceiver (such as via wireless communication or data transmission), an approval or rejection of the adjustment (or recommended adjustment) to the dynamically reconfigurable insurance product from the mobile device or other computing device of the insured; and/or (7) adjusting or updating an insurance premium and/or discount associated with the dynamically reconfigurable insurance product, at or via the insurance provider remote server, to facilitate adjusting or otherwise providing a dynamic insurance product to the insured that reflects current or changing insurance needs of the customer.

The customer data collected with the customer's consent may facilitate (i) providing more adequate or appropriate insurance coverages and/or types of insurance to the customer in a timely manner; (ii) providing more accurate behavior and/or usage-based insurance; (iii) incentivizing less risky behavior; (iv) providing recommendations that lower risk or meet changing insurance needs of the customer, such as by recommending different or new types of insurance and/or different insurance coverage or deductible amounts or levels, and/or other types of recommendations. The present embodiments may reward an insured for exhibiting risk-averse or low risk behavior in the form of lower insurance premiums or rates that may be dynamically adjusted, and/or may provide dynamic insurance discounts, points, and/or rewards. In one embodiment, the customer may opt-in to a rewards or insurance discount program.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of devices and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates various components of an exemplary system for adjusting a dynamically reconfigurable insurance product;

FIG. 2 illustrates various components of an exemplary server that may be used with the system and shown in block schematic form;

FIG. 3 illustrates various components of an exemplary mobile electronic device that may be used with the system and shown in block schematic form;

FIG. 4 illustrates an exemplary dynamically reconfigurable insurance product that changes over time based upon computer analysis of customer-related data;

FIG. 5 illustrates an exemplary computer-implemented method of adjusting a dynamically reconfigurable insurance product based upon customer-related data, and/or life event (and/or changing insurance needs) detection;

FIG. 6 illustrates an exemplary computer-implemented method of determining a type of insurance to adjust within a dynamically reconfigurable insurance product having several types of insurance based upon customer-related data, and/or life event (and/or changing insurance needs) detection;

FIG. 7 illustrates an exemplary computer-implemented method of determining a new type of insurance to add to a dynamically reconfigurable insurance product having several types of insurance based upon customer-related data, and/or life event (and/or changing insurance needs) detection;

FIG. 8 illustrates an exemplary computer-implemented method of adjusting a dynamically reconfigurable insurance product based upon customer location or GPS data, and determining likely activity and/or changing insurance needs from the customer location or GPS data (and/or life event detection);

FIG. 9 illustrates an exemplary computer-implemented method of reconfiguring a reconfigurable insurance product based upon customer engagement and/or analytics data; and

FIG. 10 illustrates an exemplary computer-implemented method of adjusting a computer-defined dynamic product based upon customer engagement and/or customer-related data, and/or life event (and/or changing insurance needs) detection.

The Figures depict exemplary embodiments for purposes of illustration only. One skilled in the art will readily recognize from the following discussion that alternative embodiments of the devices, applications, and methods illustrated herein may be employed without departing from the principles of the invention described herein.

### DETAILED DESCRIPTION

The present embodiments may relate to, inter alia, with customer permission or affirmative consent, generating and/or collecting customer or customer-related data; analyzing the customer or customer-related data; and then dynamically adjusting an insurance product based upon the customer or customer-related data and/or analysis thereof. The data generated and/or collected may be analyzed by an insurance provider server or processor to provide insurance-related benefits to an insured, and/or apply the insurance-related benefits to the dynamic insurance policy or premium.

With the present embodiments, an insurance customer may be provided with a comprehensive insurance suite that meets their unique needs over their lifetime. Conversely, conventional product(s) may constrain personalized service with the customer, such as due to a one-size-fits-all mentality; having different product types; different customers having different needs from the engagement experience; different customer needs existing based upon life stage, product relevance, available time, and/or level of knowledge; the level of accuracy and the amount of data available at any given time; and/or comfort level (for the customer, or for the insurer), which may necessitate the involvement of an agent.

As a result, customers may be overwhelmed by the number of products in the marketplace, and/or the complexity of those products. Also, each customer is unique. Each customer may have unique needs, and may not have the time, confidence, adequate understanding of their needs, and/or sufficient understanding of the available products and options. There is a burden on customers to identify risks and locate policies to address those risks, as well as identify risks based upon their individual lives and how their lives evolve over time.

Further, conventional products solutions and terms may be static, however, customer needs evolve over time. Conventional techniques may also rely upon agent and personal financial advisor expertise, customer realization of their needs, and/or may be constrained by the terms of existing agreements.

Unlike conventional products, the present embodiments may provide a “product” experience not constrained by a list of products or by temporal constraints. A dynamically changing insurance product may be flexible to evolve over time as the needs of the customer and/or their family changes (with customer permission). The insurance product may have product terms that allow for this flexibility. The dynamic changes to the insurance product may include changes in price, or the pricing may include evolution. The insurance product may include several types of insurance products—auto, home, life, renters, personal articles, etc.

Changing customer needs may be automatically met by the dynamic insurance product. For example, with customer consent or knowledge, more life insurance may be automatically provided in the event of a marriage or birth of a child. The insurance product may be personalized for the customer, and/or include no temporal constraints, such as term length. The insurance product may not be based upon a menu of products, but rather may create a solution customized to the needs of the customer. It also may be a self-healing product that reconfigures itself to meet changing customer needs. The insurance product may include a single agreement with the customer or alternatively may include several, or even an infinite, number of (short-term or long-term) agreements.

The dynamically reconfigurable insurance product may involve a continual evaluation of the customer and/or customer (or customer-related) data (such as after receiving customer consent or opt-in to a rewards or discount program), and may include satisfying customer needs dynamically. As used herein, “dynamic” may mean (in addition to its normal, plain language, or dictionary meaning) that both the customer needs and/or the insurance products are constantly or periodically changing. Embodiments of the present invention may balance these needs by human assistance and/or system intervention, however, in one embodiment, the dynamic product and various risk profiles may be primarily adjusted under the direction or control of a processor, such as an insurance provider remote server, such as a processor employing or applying machine learning techniques, object recognition or optical character recognition techniques, or other computer technology techniques or algorithms on image data, telematics data, and other types of data generated or collected by one or more home, mobile device, or vehicle sensors.

For instance, auto insurance may be based upon daily mileage needs and how much an insured commutes. If one is travelling (such as to New York City via plane and for which taxis may be used by the insured during the stay, and instead of driving their personal and insured vehicle), the “dynamic product” may, with customer permission or consent, automatically identify such a scenario (such as by analyzing telematics data, smart home data, or mobile device GPS data), and reduce auto insurance while simultaneously adding travel insurance during the time that the insured flies/travels.

As another example, the purchased “dynamic product” may include life insurance coverage that protects a spouse and/or covers a home mortgage. Later in life when a baby is born, the “dynamic” product may, with customer permission or affirmative consent, automatically evolve/adapt to include the additional life insurance needs.

The dynamic product may, again with customer permission, add temporary or permanent insurance based upon life events, customer activity or location, and/or other customer or customer-related data. In some instances, a new or different type of insurance may be added. For example, for a young adult that is getting married or having a first child and is presently without life insurance, life insurance may be added to the dynamic product and premiums adjusted accordingly. Also, based upon marriage, age, or high school or college graduation, auto insurance premiums may be adjusted or lowered. For a family having a teenager getting a driver's license, the family's or parent's auto insurance policy may automatically be adjusted accordingly.

In some instances, a type of insurance, and/or need therefore, may be reduced. In the event of the death of family member, the needs for auto insurance or life insurance for the family or another individual may decrease, and the dynamic product may be adjusted to reflect the lesser need.

In other cases, insurance types may change. For instance, a first time home buyer moving from an apartment may no longer need renters insurance, but now needs homeowners insurance. The dynamic product and/or premium may be adjusted accordingly. Other scenarios include a large purchase or sale, such as related to a home, vehicle, boat, jewelry, or antique. In such a case, insurance covering the home, vehicle, boat, jewelry, or antique may be added or dropped depending upon whether the item was acquired or sold.

The dynamic product may be adjusted before a conventional time period for insurance (such as 6 months) has expired. Thus, the dynamic product may not be constrained by periodic payments and/or adjustments. Rather, premiums/policies may be dynamically adjusted to more accurately reflect current levels of risk, or lack thereof, for the customer and/or their belongings.

In one scenario, the dynamic product may be adjusted based upon customer location (with customer permission), such as a GPS location received from their vehicle or mobile device. For instance, if a person is traveling and has left their insured house empty for a given period of time, their home insurance and/or personal articles insurance may be adjusted to reflect an increased level of risk. On the other hand, when the homeowner returns home, the dynamic product may be adjusted to reflect a lower level of risk.

In one embodiment, auto insurance, renters insurance, personal articles insurance, and/or homeowners insurance may all be dynamically adjusted based upon customer GPS data. For instance, a person may work and stay in the city (e.g., at an apartment) during the work week, and then return to a rural home on the weekend. Their auto insurance, and/or other types of insurance, may be adjusted to reflect a higher or lower risk level during the week or on the weekend, depending on the situation and/or locations. For instance, either the apartment or rural home may have additional people living there, and/or have security (e.g., doorman) or security systems that may impact risk levels associated with leaving the premises unoccupied for one or more days.

Also, GPS location may be monitored, such as after receiving customer affirmative consent or permission (or opt-in to an insurance discount or rewards program), to determine when the customer is likely traveling. For instance, when the customer is about to cross a state line, they may be on a lengthy trip—which may be monitored and/or detected by receiving and analyzing GPS data from the customer's vehicle and/or mobile device. When it is determined that the customer is likely on a lengthy trip, a message may be transmitted to their vehicle or mobile device via wireless communication for confirmation. Once it is confirmed that the insured is on a lengthy trip, such as receiving a confirmation from the insured's mobile device at an insurance provider remote server via wireless communication or data transmission, the dynamic product may adjust their auto, home, life, personal articles, travel, and/or other types of insurance accordingly. The GPS data may also be used to adjust distance or mileage-based (e.g., pay-per-mile) auto insurance, and/or adjust travel insurance.

As the dynamic product is adjusted or updated, various liability or other coverages (or deductibles, limits, premiums, etc.) may be scaled up, or scaled down. After which, the customer may be promptly notified, such as via wireless communication or data transmission from an insurance provider remote server to their mobile device. The customer may accept or reject the changes via their mobile device and wireless communication back to the remote server.

The dynamic product may include layering of risk, value, and/or data in a dynamically shaping “product” to match customer expectations and/or needs via the ebb and flow of their life. The dynamic product may be defined and evolved by the customer needs and not by the insurance provider, per se. The dynamic product may be managed such that it adapts to the individual customer needs via flexible business processes, flexible data usage, and/or the ability to evolve where necessary.

The methods and systems described herein may be implemented using computer programming or engineering techniques including computer software, firmware, hardware, or any combination or subset. At least one of the technical problems addressed by this system includes: (i) inconvenient and imprecise remote comparison between prior and current life situation or living conditions; (ii) difficulty quantifying and cataloging any differences between dynamic life situations, living conditions or life events; and/or (iii) an inability to provide guidance as perceived and actual level of risk based upon an individual's current situation.

The technical effect achieved by this system is at least one of: (i) more convenient and efficient remote comparison between a prior life situation of an individual (or household) and a current life situation; (ii) simpler quantification and characterization of differences between prior and current dynamic life situations, living conditions or life events; (iii) situation-based guidance based upon a current dynamically changing level of risk for an individual or household; (iv) dynamic analysis and determination of updated risk levels or profiles for a handful of components that together comprise the dynamically reconfigurable product, those components may include auto, life, home, renters, personal articles, pet, burial, other types of insurance, an/or financial products (checking and savings accounts, loans, etc.); and (v) training and using machine learning techniques to identify life events, and quantify changes in risk associated with each life event identified to update the dynamic product accordingly (such as adjust insurance coverages, deductibles, and/or limits to more accurately reflect changes in life circumstances).

Additional technical effects, as well as insurance-related benefits, provided by the present embodiments may include, inter alia: (1) more appropriate levels of insurance; (2) more appropriate types of insurance coverage; (3) more timely binding of insurance based upon, at least in part, real-time or near real-time analysis of customer or customer-related data, and/or customer or insured vehicle location; (4) more timely identification of risk, or lack thereof (and/or of associated risk level), to the insured or their belongings (home, vehicle, jewelry, etc.); (5) more accurate behavior or usage-based insurance and/or premiums; (6) incentivizing low risk or less risky behavior for an insured; (7) providing recommendations that reduce risk and/or result in insurance savings for the insured; (8) identifying more accurate risk or risk levels in real-time or near real-time; and/or other insurance-related benefits. The present embodiments may reward an insured for exhibiting risk-averse behavior in the form of lower insurance premiums or rates, or additional insurance discounts provided in real-time or approximately real-time.

Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

### Exemplary System

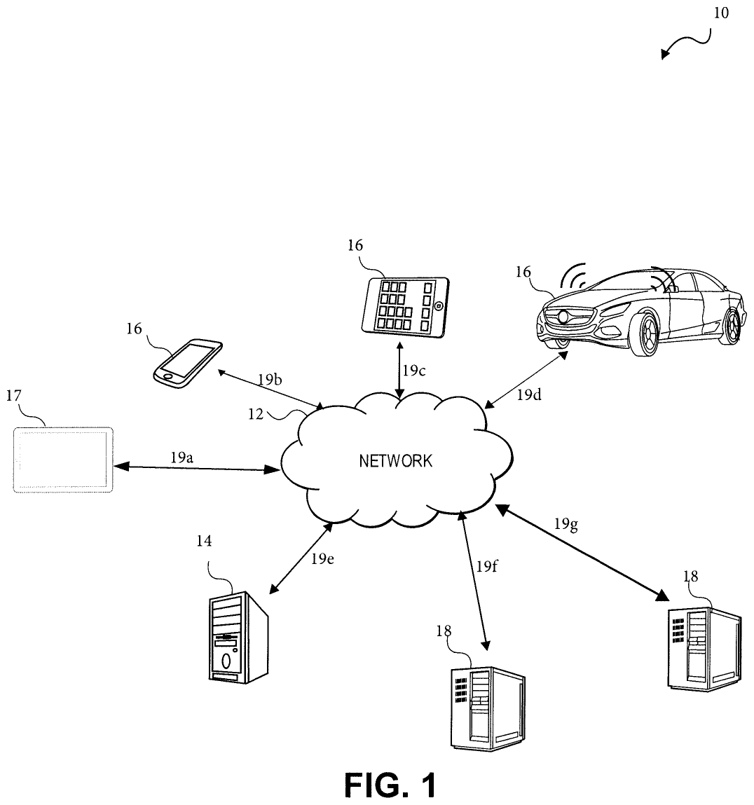

FIG. 1 depicts an exemplary environment in which embodiments of a system 10 may be utilized for transmitting and receiving location information and other customer-related data, dynamic insurance product adjustment notifications, and other information described herein or fairly drawn therefrom by one of ordinary skill (the “system information”). The environment may include a network 12 and computer server 14 as seen in FIG. 1, with which the system 10 interfaces to send and receive system information. The system 10 may broadly comprise one or more customer mobile electronic devices 16, the aforementioned server 14 (which may be a remote server), databases 18, and/or a local (home) network or smart home controller 17. The system 10 may thus be utilized to automatically communicate with customers and/or their mobile electronic devices 16, insurance providers and/or their computer server(s) 14, and/or external databases 18 such as those operated by social media website operators, and other sources for customer-related data, including the local or home network, and/or smart home controller 17.

The network 12 (and/or the local (home) network or smart home controller 17) may generally allow communication between the mobile electronic devices 16 and the server 14, and also between the server 14 and the databases 18. The network 12 (and/or the local (home) network or smart home controller 17) may include local area networks, metro area networks, wide area networks, cloud networks, the Internet, cellular networks, plain old telephone service (POTS) networks, and the like, or combinations thereof. The network 12 (and/or the local (home) network or smart home controller 17) may be wired, wireless, or combinations thereof and may include components such as modems, gateways, switches, routers, hubs, access points, repeaters, towers, and the like. The mobile electronic devices 16 generally connect to the network 12 (and/or the local (home) network or smart home controller 17) wirelessly, such as radio frequency (RF) communication using wireless standards such as cellular 2G, 3G, or 4G, Institute of Electrical and Electronics Engineers (IEEE) 802.11 standards such as WiFi, IEEE 802.16 standards such as WiMAX, Bluetooth®, or combinations thereof.

The server 14 generally retains electronic data and may respond to requests to retrieve data as well as to store data. The server 14 may be embodied by application servers, database servers, file servers, gaming servers, mail servers, print servers, web servers, or the like, or combinations thereof. Furthermore, the computer server 14 may include a plurality of servers, virtual servers, or combinations thereof. The computer server 14 may be configured to include or execute software such as file storage applications, database applications, email or messaging applications, web server applications, or the like. The computer server 14 may apply business methods or algorithms, may utilize lookup tables or databases, or combinations thereof to determine insurance rates or premiums, insurance types or scope, or similar characteristics of insurance coverage. Insurance providers may own one or more computer servers 14 that may, with customer permission or affirmative consent, automatically collect and analyze customer-related data and information about insurance policies and coverage criteria.

In one aspect, the exemplary computing technologies and system 10 shown in FIG. 1 may include a network 12, one or more vehicles 16 and respective mobile computing devices 16 (such as smart phones, laptops, tablets, electronic wearables, and other computing devices capable of RF communication), and one or more external computing devices 14 or databases 18. In one aspect, mobile computing devices 16 may be implemented within a vehicle or smart vehicle that may have an associated on-board computer. Each vehicle may be configured for wireless inter-vehicle communication, such as vehicle-to-vehicle (V2V) wireless communication and/or data transmission.

Various aspects may include system 10 implementing any suitable number of networks 12, mobile computing devices or smart vehicles 16, external computing devices 14, and/or local home networks or smart home controllers 17. For example, system 10 may include a plurality of external computing devices 14 and more than two mobile computing devices 16, any suitable number of which being interconnected directly to one another and/or via network 12.

In one aspect, each of mobile computing devices 16 may be configured to communicate with one another directly via peer-to-peer (P2P) wireless communication and/or data transfer. In other aspects, each of mobile computing devices 16 may be configured to communicate indirectly with one another and/or any suitable device via communications over network 12, such as external computing device 14, for example. In still other aspects, each of mobile computing devices 16 may be configured to communicate directly and indirectly with one and/or any suitable device, which may be concurrent communications or communications occurring at separate times.

Each of mobile computing devices 16 may be configured to send data to and/or receive data from one another and/or via network 12 using one or more suitable communication protocols, which may be the same communication protocols or different communication protocols as one another. To provide an example, mobile computing devices 16 may be configured to communicate with one another via a direct radio link, which may utilize, for example, a Wi-Fi direct protocol, an ad-hoc cellular communication protocol, etc. Furthermore, mobile computing devices 16 may be configured to communicate with the vehicle on-board computers located in vehicles utilizing a Bluetooth® communication protocol (radio link not shown).

To provide additional examples, mobile computing devices 16 may be configured to communicate with one another via radio links 19b, 19c, 19d, 19a by each communicating with network 12 or smart home controller/local home network 17 utilizing a cellular communication protocol. As an additional example, mobile computing devices 16 may be configured to communicate with external computing device or server 14, and/or databases 18 via radio links 19b, 19c, 19d, 19e, 19f, and/or 19g. Still further, one or more of mobile computing devices 16 may also be configured to communicate with one or more smart components directly and/or indirectly using any suitable communication protocols and radio links.

Mobile computing devices 16 may be configured to execute one or more machine learning algorithms, programs, applications, etc., to determine a geographic location of each respective mobile computing device; to generate, measure, monitor, and/or collect one or more sensor metrics, and/or types of data, such as vehicle or home telematics data; to broadcast the data generated or collected via their respective radio links; to receive data or instructions via their respective radio links; to determine whether an adjustment to the dynamic product, or a risk or other component of the dynamic product should be generated, or whether a life event (or other change in living situation or circumstances) has occurred based upon analysis of the data generated or collected; to generate the one or more notifications to the customer, and/or to broadcast the notifications.

Network 12 may be implemented as any suitable network configured to facilitate communications between mobile computing devices 16 and one or more of external computing device 14 and/or smart home controller or local home network 20. For example, network 12 may include one or more telecommunication networks, nodes, and/or links used to facilitate data exchanges between one or more devices, and may facilitate a connection to the Internet for devices configured to communicate with network 12. Network 12 may include any suitable number of interconnected network components that form an aggregate network system, such as dedicated access lines, plain ordinary telephone lines, satellite links, cellular base stations, a public switched telephone network (PSTN), etc., or any suitable combination thereof. Network 12 may include, for example, a proprietary network, a secure public internet, a secure electronic communication network, a mobile-based network, a virtual private network, etc.

In aspects in which network 12 facilitates a connection to the Internet, data communications may take place over the network 12 via one or more suitable Internet communication protocols. For example, network 12 may be implemented as a wireless telephony network (e.g., GSM, CDMA, LTE, etc.), a Wi-Fi network (e.g., via one or more IEEE 802.11 Standards), a WiMAX network, a Bluetooth network, etc. Thus, radio links 19a-19g may represent wired links, wireless links, or any suitable combination thereof.

In aspects in which mobile computing devices 16 communicate directly with one another in a peer-to-peer fashion, network 12 may be bypassed and thus communications between mobile computing devices 16 and external computing device 16 may be unnecessary. For example, in some aspects, one mobile computing device 16 may broadcast data directly to another mobile computing device. In this case, mobile computing device 16 may operate independently of network 12 to determine whether a life event or a change in living conditions has occurred and/or whether an alert or notification should be generated at mobile computing device 16 based upon data collected or generated via one or more sensors or a sensor array, such as mobile device, vehicle, or home-mounted sensors. In accordance with such aspects, network 12 may be omitted.

However, in other aspects, one or more of mobile computing devices 16 may work in conjunction with external computing device 14 to determine whether a life event or change in living conditions has occurred and/or to generate or adjust the dynamic product. For example, in some aspects, mobile computing device 16 may broadcast data generated or collected by one or more sensors (including cameras), which is received by external computing device 14. In this case, external computing device 14 may be configured to apply machine learning techniques on the data received and determine whether a life event or change in living conditions has occurred and/or whether a proposed adjustment to the dynamic product should be transmitted to the mobile computing device 16.

External computing device 14 may be configured to execute various machine learning techniques, object recognition and optical character recognition techniques, software applications, algorithms, and/or other suitable programs. External computing device 14 may be implemented as any suitable type of device to facilitate the functionality as described herein. For example, external computing device 14 may be implemented as a network server, a web-server, a database server, one or more databases and/or storage devices, or any suitable combination thereof. Although illustrated as a single device in FIG. 1, one or more portions of external computing device 14 may be implemented as one or more storage devices that are physically co-located with external computing device 14, or as one or more storage devices utilizing different storage locations as a shared database structure (e.g. cloud storage).

In some embodiments, external computing device 14 may be configured to perform any suitable portion of the processing functions remotely that have been outsourced by one or more of mobile computing devices 16. For example, mobile computing device 16 may collect data (e.g., geographic location data, telematics data, image or audio data, other type of sensor data, time-stamped data, other types of data units, etc.), but may send the data (or data units) to external computing device 14 for remote processing instead of processing the data (or data units) locally. In such embodiments, external computing device 14 may receive and process the data (or data units) to determine whether an anomalous condition exists (such as whether a life event, or change in living conditions, has occurred or has likely occurred or is predicted to occur shortly) and, if so, whether to adjust the dynamic product, and/or transmit a proposed adjustment to the dynamic product to one or more mobile computing devices 16 for customer review.

In one aspect, external computing device 14 may additionally or alternatively be part of an insurer computing system (or facilitate communications with an insurer computer system), and as such may access insurer databases, execute algorithms, execute applications, access remote servers, communicate with remote processors, etc., as needed to perform insurance-related functions. For example, external computing device 14 may facilitate the receipt of smart home or vehicle telematics data or other data from one or more mobile computing devices 16 and/or smart home controller 17, which may be associated with insurance customers and/or running a telematics application that generates and broadcasts telematics data.

In aspects in which external computing device 14 facilitates communications with an insurer computing system (or is part of such a system), data received from one or more mobile computing devices 16 may include logon credentials which may be verified by external computing device 14 or one or more other external computing devices, servers, etc. These logon credentials may be associated with an insurer profile, which may include, for example, insurance policy numbers, a description and/or listing of insured assets, vehicle identification numbers of insured vehicles, addresses of insured structures, contact information, premium rates, discounts, etc.

In this way, data received from one or more mobile computing devices 16 may allow external computing device 14 to uniquely identify each insured customer and/or whether each identified insurance customer has installed the telematics application on their mobile device 16. Furthermore, any data collected from one or more mobile computing devices 16 may be referenced to each insurance customer and/or any insurance policies associated with each insurance customer for various insurance-related purposes.

In one embodiment, smart home controller 17 may be in wired or wireless communication with a plurality of processor/sensor pairs located about a home, and/or a home mounted sensor array. The sensors may generate or collect data, and transmit (via a transceiver) the data collected to the smart home controller 17 or a remote or external server 14 for further analysis, such as detecting anomalous or changed conditions (by using, for example, machine learning techniques on the sensor data), which may indicate a change in living situation, or a life event.

For instance, each home-mounted sensor may be in wireless RF communication with the smart home controller 17 or remote server 14 via one or more radio links that utilize an IEEE communication standard. Once the data generated by one or more sensors mounted on, or located about, a house is received by the smart home controller 20 or remote server 14, the smart home controller 17 or remote server 14 may compare the data with a baseline of expected conditions or data units to determine changes in the living situation within the home.

### Exemplary Server And Mobile Devices

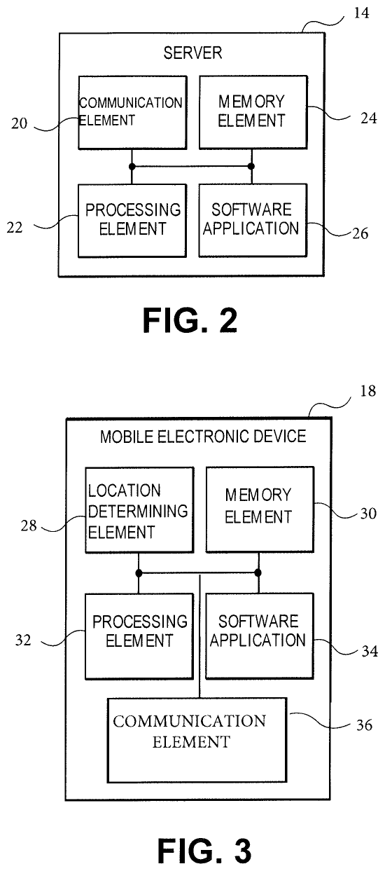

As shown in FIG. 2, the server 14 may include a communication element 20, a processing element 22, a memory element 24, and a software application 26 configured to control its function according to various embodiments described herein and otherwise within the scope of the invention.

The communication element 20 generally allows communication with external systems or devices. The communication element 20 may include signal or data transmitting and receiving circuits, such as antennas, amplifiers, filters, mixers, oscillators, digital signal processors (DSPs), and the like. The communication element 20 may establish communication wirelessly by utilizing RF signals and/or data that comply with communication standards such as cellular 2G, 3G, or 4G, IEEE 802.11 standard such as WiFi, IEEE 802.16 standard such as WiMAX, BluetoothTM, or combinations thereof. Alternatively, or in addition, the communication element 20 may establish communication through connectors or couplers that receive metal conductor wires or cables which are compatible with networking technologies such as ethernet. In certain embodiments, the communication element 20 may also couple with optical fiber cables. The communication element 20 may be in communication with or electronically coupled to memory element 24 and/or processing element 22.

The memory element 24 may include data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, USB ports, or the like, or combinations thereof. The memory element 24 may include, or may constitute, a “computer-readable medium”. The memory element 24 may store the instructions, code, code segments, software, firmware, programs, applications, apps, services, daemons, or the like that are executed by the processing element 22. The memory element 24 may also store settings, data, documents, sound files, photographs, movies, images, databases, and the like.

The processing element 22 may include processors, microprocessors, microcontrollers, DSPs, field-programmable gate arrays (FPGAs), analog and/or digital application-specific integrated circuits (ASICs), or the like, or combinations thereof. The processing element 22 may generally execute, process, or run instructions, code, code segments, software, firmware, programs, applications, apps, processes, services, daemons, or the like. The processing element 22 may also include hardware components, such as finite-state machines, sequential and combinational logic, and other electronic circuits that may perform the functions necessary for the operation of embodiments of the current inventive concept. The processing element 22 may be in communication with the other electronic components through serial or parallel links that include address busses, data busses, control lines, and the like.

Software application 26 may be configured to instruct the collection of customer-related data from mobile electronic devices 18 and/or from other data sources (such as storage devices 18), such as after receiving customer permission. Software application 26 may therefore be configured to instruct the performance of functions commonly associated with Internet “web crawlers” or the like and/or may be more narrowly focused on a plurality of data sources known to house data particularly relevant to configuring a dynamically adjustable insurance product.

Software application 26 may be self-configured to determine a likelihood that a data source will house relevant data, for example based upon analysis of how frequently a proposed dynamic product adjustment is accepted or ultimately adopted when proposed based upon analysis of data from such a source. For another example, software application 26 may also be self-configured to select relevant data sources based upon a plurality of pre-programmed investigative rules. Put another way, pre-programmed rules may comprise weighted or un-weighted indicia of relevance, configured such that the more rules or conditions data from a data source satisfies, the greater relevance is assigned to such a data source, leading to a self-configured preference for investigating that data source. A data source may be catalogued as having a certain degree of relevance, or as being worthy of investigation or not, or may otherwise be flagged for future action or inaction by the server 14 in connection with its investigations, in a data source database stored in memory element 24. Each data source may be catalogued according to IP address(es), URL address(es), proprietor, operator, and/or by other information useful in identifying the source(s) of data or content accessible via the network 12.

Customer-related data collected via instruction of the software application 26 may be analyzed at or via the processing element 22 according to the principles set forth herein to determine, for example, whether an event that may impact an aspect of an insurance product has occurred or may occur. The server 14 may further cause issuance of a notification to a customer, for example to the customer's mobile electronic device 18, indicating an adjustment to a dynamically reconfigurable insurance product has been or is expected to be made and/or requested consent for such a change.

It is envisioned that the software application 26 may be configured to instruct the performance of additional or fewer steps of the present inventive concept at or via the server 14.

The data storage devices 18 generally store data and each is typically embodied by a data server and may include storage area networks, application servers, database servers, file servers, gaming servers, mail servers, print servers, web servers, or the like, or combinations thereof. The data storage devices 18 may be additionally or alternatively embodied by computers, such as desktop computers, workstation computers, or the like.

In addition, the data storage devices 18 may be configured to transmit and receive data to and from other devices. The data storage devices 18 may have various performance specifications such as bandwidth available, jitter, latency, capacity or throughput, and the like. Furthermore, the data storage devices 18 may have one or more currently running jobs, as well as a queue of planned jobs for the future.

The mobile electronic devices 18 may be embodied by a smart watch, a smart phone, a personal digital assistant (PDA), a tablet, a palmtop or laptop computer, smart glasses, or other mobile device, and is typically carried by the customer while driving. A mobile electronic device 18 may also be embodied by onboard automotive components such as a GPS receiver coupled to a wireless transmitter or other onboard telematics data-gathering equipment. The mobile electronic devices 18 may include location determining elements 28 such as GPS receivers, memory elements 30, processing elements 32, software applications 34 and/or communications elements 36, as seen in FIG. 3. The memory elements 30 may store the software applications 34, and the processing elements 32 may execute the software applications 34.

The majority of components of the mobile electronic devices 18—more specifically, the communications elements 36, processing elements 32, and memory elements 30—each operate under similar principles to those set forth above with respect to analogous components of the server 14. The location determining element 28 determines a current geolocation of the electronic device 18 and may receive and process radio frequency (RF) signals from a global navigation satellite system (GNSS) such as the global positioning system (GPS) primarily used in the United States, the GLONASS system primarily used in the Soviet Union, or the Galileo system primarily used in Europe. The location determining element 28 may accompany or include an antenna to assist in receiving the satellite signals. The antenna may be a patch antenna, a linear antenna, or any other type of antenna that can be used with location or navigation devices. The location determining element 28 may include satellite navigation receivers, processors, controllers, other computing devices, or combinations thereof, and memory. The location determining element 28 may process a signal, referred to herein as a “location signal”, from one or more satellites that includes data from which geographic information such as the current geolocation is derived. The current geolocation may include coordinates, such as the latitude and longitude, of the current location of the electronic device 18. The location determining element 28 may communicate the current geolocation to the processing element 32.

Although embodiments of the location determining element 28 may include a satellite navigation receiver, it will be appreciated that other location-determining technology may be used. For example, cellular towers or any customized transmitting radio frequency towers can be used instead of satellites may be used to determine the location of the electronic device 18 by receiving data from at least three transmitting locations and then performing basic triangulation calculations to determine the relative position of the device with respect to the transmitting locations. With such a configuration, any standard geometric triangulation algorithm can be used to determine the location of the electronic device. The location determining element 28 may also include or be coupled with a pedometer, accelerometer, compass, or other dead-reckoning components which allow it to determine the location of the electronic device 18. The location determining element 28 may determine the current geographic location through a communications network, such as by using Assisted GPS (A-GPS), or from another electronic device. The location determining element 28 may even receive location data directly from a user.

### Exemplary Machine Learning

The processing element 22 may utilize machine learning programs or techniques. For instance, the processing element 22 may utilize the information from the existing dynamic product and sensor data collected, and apply that data to one or more machine learning techniques to generate a resident profile of the household. The processing element 22 and/or machine learning techniques may recognize or determine patterns of activity or behavior from the sensor data. The machine learning techniques or programs may include curve fitting, regression model builders, convolutional or deep learning neural networks, or the like. The processing element 22 and/or machine learning techniques may further associate activity patterns from the sensor data with individuals or pets that are known to live in the house, and/or determine when an individual or pet has joined the household from analysis of sensor data collected over time.

Based upon this data analysis, the processing element 22 and/or machine learning techniques may generate the resident profile of the household. The resident profile may include the number of residents of the household, the number of pets, and the like. The processing element 22 and/or machine learning techniques may utilize the resident profile in combination with information regarding features of the house to determine a level of risk for the household; and may also utilize the resident profile to determine when there is a change in the residency of the household, such as the adoption of a child, the birth of a baby, the addition of a pet, the moving out of a child to an apartment or college, or the like.

As noted, data associated with the dynamic product, and/or auto, life, health, homeowners, pet or other components of the dynamic product may be input into a machine learning program. The machine learning program may include curve fitting, regression model builders, convolutional or deep learning neural networks, or the like. The machine learning program may associate activity patterns from the sensor data with individuals or pets that are known to live in the house. Each mobile device may have a unique ID, although it is not necessarily known which household member carries each mobile device. However, this information may be inferred from the sensor data. For example, if it is known from the dynamic product information that the household includes two adults and one teenager, then one of the mobile devices may arrive at the house in mid or late afternoon every weekday. The machine learning program may determine that the particular mobile device belongs to the teenager and that all of the activity that is recorded in the house before another mobile device arrives at the house is generated from the teenager. The machine learning program may further determine patterns of activity or behavior that can be attributed to a first individual—the teenager, in this case. The machine learning program may then utilize the patterns to predict future activity of the first individual. The machine learning program may also use the patterns to isolate the activity of the first individual from the activities of other individuals in the house and thus be able to determine patterns of activity of the other individuals. Furthermore, if the dynamic product information includes gender information regarding the residents of the house, then the machine learning program may be able to establish gender-dependent patterns of activity or behavior that may be used to identify individuals or predict activity based upon gender. Based upon this data analysis, the machine learning program may generate the resident profile of the household. The resident profile may include the number of residents of the household, the gender of the residents, the number and types of pets, and the like.

Based upon the patterns of activity, the machine learning program may also calculate or estimate a level of risk for a household. In one embodiment, based upon the level of risk, or an adjusted risk profile for the household, a premium or discount for a homeowner's insurance component of the dynamic product may be calculated. The amount of the premium or discount may vary according to the patterns of activity within the home, data from a resident profile, and/or data regarding features of the house. The processing element 22 may also utilize the machine learning program and the resident profile to determine when there is a change in the residency of the household, such as the adoption of a child, the birth of a baby, the addition of a pet, the moving out of a child to an apartment or college, or the like. The processing element 22 may further adjust the premium or discount for the dynamic product in response to changes in the residency profile.

A. Life & Health Product Components & Risk Profile

The machine learning may also relate to, inter alia, evaluating insurance applicants as part of an underwriting process to determine appropriate premiums and/or other terms of coverage. Broadly characterized, a processing element may be trained to probablistically analyze still and/or moving (i.e., video) images and/or voice recordings of applicants to determine personal and/or health-related information for an insurance provider. More specifically, the dynamically reconfigurable insurance product may include a life and/or health insurance component.

In one embodiment, an individual may provide, using their mobile device 16 and one or more radio links, one or more still and/or moving (i.e., video) images and/or voice recordings of him- or herself to a remote server or external computing device 14. The remote server or external computing device 14 may include a processing element 22 and/or machine learning program that analyze the image and/or audio data to determine personal and/or health-related information relevant to an underwriting process. The information may be used to determine whether and under what terms, including appropriate premiums or discounts, the life or health insurance component of the overall dynamic product should be offered to the applicant.

For instance, machine learning may involve identifying and recognizing patterns in existing data in order to facilitate making predictions for subsequent data. Models may be created based upon example inputs in order to make valid and reliable predictions for novel inputs. In supervised machine learning, the processing element 22 may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element 22 may be required to find its own structure in unlabeled example inputs. In one embodiment, machine learning techniques may be used to extract the relevant personal and/or health-related information for insurance applicants from images and/or voice recordings of those applicants without needing to acquire samples of bodily fluids or conduct conventional medical reviews.

In one embodiment, the processing element 22 may be trained by providing it with a large sample of otherwise non-diagnostic conventional analog and/or digital, still and/or moving (i.e., video) images and/or voice recordings of persons with known personal and/or health-related information about the persons to analyze for correlations between detectable characteristics and the known information. Such information may include, for example, age, sex, weight, and height; tobacco, alcohol, and drug use; diet; existing medical conditions and risk factors for future medical conditions; expected lifespan and cause of death; and insurance premiums. Based upon these analyses, the processing element 22 may learn how to identify characteristics and patterns that may then be applied to analyzing images of new insurance applicants. For example, the processing element 22 may learn to determine an individual's pulse from a video of the applicant, may learn to identify medication or other drug use by the applicant through, e.g., eye movement, and/or may learn to determine such other information as the applicant's glucose level. Similarly, the processing element 22 may learn to identify indications of certain diseases, disorders, and/or behaviors from a voice recording of the applicant.

Referring to FIG. 1, once trained using the sample data, the processing element 22 may receive a still and/or moving (i.e., video) image and/or voice recording of an insurance applicant and/or members of their household from their mobile device 16 over one or more radio links 19a-g, and may probablistically determine the personal and/or health-related characteristic for the insurance applicant and/or their household. The resulting data may be used to determine a risk level or profile associated with a life and/or health insurance components of the dynamically reconfigurable insurance product. The resulting data may also verify information provided by the applicant and/or answering underwriting questions, and/or may be used to substantially automate the underwriting process by directly predicting or estimating the actual level of risk and recommending a corresponding amount of insurance coverage based upon the level or risk and/or other factors, such as age and number of dependents. The applicant may then quickly be provided with a rate quote for a new or updated dynamic product, such as via communication with their mobile device 16 over one or more radio links 19a-g.

The large sample of still and/or moving (e.g., video) images and/or voice recordings used to train the processing element 22 may be, for example, provided by volunteers. The still and/or moving (e.g., video) image and/or voice recording received from the applicant may be analog or digital and otherwise non-diagnostic and conventional in nature, such as an ordinary “selfie” taken by the insurance applicant or him- or herself. The videos may include audio of the applicants' voices, and the processing element's 22 training and analysis may include similarly seeking relevant characteristics or patterns in voices. The processing element's 22 analyses of images may be probabilistic, such that the resulting data may be associated with varying degrees of certainty.

The processing element 22 may employ a neural network, which may be a convolutional neural network (CNN) and/or a deep learning neural network. A CNN is a type of feed-forward neural network often used in facial recognition systems, in which individual neurons may be tiled so as to respond to overlapping regions in the visual field. A CNN may include multiple layers of small neuron collections which examine small portions of an input image, called receptive fields. The results of these collections may be tiled so that they overlap to better represent the original image, and this may be repeated for each layer. Deep learning involves algorithms that attempt to model high-level abstractions in data by using model architectures, with complex structures or otherwise, composed of multiple non-linear transformations. An image may be represented in various ways, such as a vector of intensity values per pixel, a set of edges, or regions of particular shape. Certain representations may better facilitate learning how to identify personal and health-related information from examples.

Thus, the present embodiments may be used to probablistically evaluate applicants for life or health insurance components of the dynamic product and determine appropriate premiums or other terms of coverage based upon analyses of still and/or moving images, and/or voice recordings of the applicants and without requiring conventional medical examinations.

B. Homeowners or Renter Component & Risk Profile

In one aspect, a property may have a “smart” central controller that may be wirelessly connected, or connected via hard-wire, with various household related items, devices, and/or sensors. The central controller may be associated with any type of property, such as homes, office buildings, restaurants, farms, and/or other types of properties. The central controller may be in wireless or wired communication with various “smart” items or devices, such as smart appliances (e.g., clothes washer, dryer, dish washer, refrigerator, etc.); smart heating devices (e.g., furnace, space heater, etc.); smart cooling devices (e.g., air conditioning units, fans, ceiling fans, etc.); smart plumbing fixtures (e.g., toilets, showers, water heaters, piping, interior and yard sprinklers, etc.); smart cooking devices (e.g., stoves, ovens, grills, microwaves, etc.); smart wiring, lighting, and lamps; smart personal vehicles; smart thermostats; smart windows, doors, or garage doors; smart window blinds or shutters; and/or other smart devices and/or sensors capable of wireless or wired communication. Each smart device (and/or sensor associated therewith), as well as the central controller, may be equipped with a processor, memory unit, software applications, wireless transceivers, local power supply, various types of sensors, and/or other components.

The smart home controller 17 may be in communication with smart appliances. When new appliances are detected to have entered the home, or appliances detected to have left the home, a running virtual inventory of personal articles or personal belongings may be updated and determination made by the smart home controller 17 or external device 14 of whether or not an increase or decrease in personal articles or homeowners insurance is appropriate. The appliances may be identified by, for example, data that includes make and model information that is transmitted by the appliances, or object recognition or optical character recognition (or machine learning) techniques performed by the smart home controller 17 or external device on image data received from one or more cameras mounted about a home, such as a security system.

In other aspects, the sensors may include security systems, video or cameras that acquire image and/or audio data, and/or motion or infrared sensors which detect when people or animals are moving inside or outside the house. The sensor data (e.g., image or infrared data) may be collected over time at the smart home controller 17 and/or external device or server 14, and used to determine when an additional person or pet has moved in, or left the household.

In one embodiment, facial recognition techniques may be performed on the image data received from one or more home-mounted cameras to identify members of the household and when the composition of the household has changed. For instance, when person is identified as not belonging to the current household, an analysis may be performed of time-stamped images to determine how often that person is in the home and when—such as, a person that is routinely sleeping at the home during night time hours is likely a new member of the household. Conversely, when it is determined that a member of the household has not been captured within images taken by the home-mounted cameras for a given amount of time, such as a month, then it may be determined that that person is no longer, or likely no longer, a member of the household.

The smart home controller 17 and/or external device or server 14 may also analyze time-stamped image data to determine or estimate an amount time during an average day or week that the home is occupied or unoccupied, and time of day or night that the home is occupied or unoccupied. Based upon the number of home occupants and/or the amount of time in each day that someone is at home (or the home is unoccupied), the smart home controller 17 and/or external device or server 14 may determine a risk profile for the household and/or that an increase or decrease in a homeowners or renters insurance component of the dynamic product is warranted or recommended.

In one embodiment, the sensor data may be transmitted from the sensors to a central hub or smart home controller 17 which forwards the data to an external computing device 14 via one or more radio links 19a-19g. At various intervals, the external computing device 14 may generate a report that summarizes the sensor data. The external computing device 14 may also receive data derived from dynamically reconfigurable insurance product. The data from the report and the dynamic reconfigurable product may be input into a machine learning program. The program may recognize patterns of activity from the sensor data and may generate a resident profile, or risk level or score. The resident profile along with data regarding the features of the house, household, and/or individual may be utilized to calculate a premium for the dynamically reconfigurable product, and/or propose adjustments coverages, deductibles, or limits and/or changes to types of insurance (such as homeowners, renters, or personal articles insurance) within the dynamic product for the individual's or customer's review and approval.

In another aspect, machine learning (as discussed elsewhere herein) may be applied to the smart home data, such as image data, collected and generated from various home-mounted sensors (e.g., security cameras) to determine one or more home features. The home features may include number of rooms; size of rooms; type of rooms (kitchen, bath, master bedroom, etc.); type of flooring, windows, ceilings, cabinets, and counter tops; age and type of roof; type of exterior; type of basement (finished or not); type of security system; etc.). The machine learning techniques may be used to extract the relevant home feature or characteristic-related information for homeowners insurance from images and/or other data collected from home sensors or electronic devices.

For instance, the processing element 22 may be trained by providing it with a large sample of conventional analog and/or digital, still and/or moving (i.e., video) images of homes with known features or characteristics to analyze for correlations between detectable features or characteristics and the known information. Such information may include, for example, type of flooring, cabinets, ceilings, counter tops, windows, roofing, age of home or roof, etc. Based upon these analyses, the processing element 22 may learn how to identify home characteristics and patterns that may then be applied to analyzing images of new homes.

Once trained using the sample data, the processing element 22 may receive a still and/or moving (i.e., video) image of home of an insurance applicant from their mobile device 16 or smart home controller 17 over one or more radio links 19a-g, and may probablistically determine one or more home features or characteristics. The resulting data may be used to determine a risk level or profile associated with homeowners or renters insurance component of the dynamically reconfigurable insurance product. The dynamic product may then be generated or adjusted based upon risk level or profile associated with the home or apartment.

C. Dynamic Personal Articles Component & Risk Profile

The methods and systems may include a unique combination of processes and technology, based upon, for example, an object recognition (OR) algorithm (and/or optical character recognition (OCR) algorithm) or other machine learning technique that automatically identifies a personal article using at least one digital image of the personal article. For example, a personal article category (e.g., jewelry, computers, tools, firearms, etc.) may be determined by using an object recognition algorithm to process at least one digital image of the personal article. The methods and systems may automatically identify at least one document (e.g., an appraisal, a purchase receipt, etc.) associated with a personal article using, for example, an optical character recognition (OCR) algorithm.

The methods and systems may validate that, for example, an appraisal matches an associated personal article. The methods and systems may validate that a personal article is authentic. An object or optical character recognition (or other machine learning) technique may automatically identify data attributes contained within document(s) associated with a personal article. The systems and methods may collect data (e.g., appraisal dates, quality measures, dollar amounts, etc.) associated with a personal article. Metadata may be extracted from data that is representative of at least one digital image of a personal article, and may be collected for potential use in data pre-population, underwriting, fraud detection, etc. Date/time stamps, geo-tags, etc. may also be extracted from data that is representative of at least one digital image of a personal article. The methods and systems may include processes that pre-populate the extracted data into workflows.

The processing element 22 may execute an object recognition/optical character recognition (or other machine learning) module, which may be software application 26, to extract personal articles information data from digital images of personal belongings, and/or the digital images of the supporting documentation (such as appliance owner's manuals)—the digital images received from the smart home controller 17 or mobile device 16 via one or more radio links.

Processing element 22 may execute a personal articles insurance policy user interface module to cause the processing element 22 to generate a personal articles inventory based upon one or more of an identified type, an identified characteristic and/or an estimated value. The inventory may be associated with a specific insured or family, and may include the type and features of various belongings, their estimated value, and/or their purchase or replacement cost.

Processing element 22 may execute an insurance-related action to be performed based upon the personal articles inventory. For instance, the processing element 22 may generate or adjust a quote, premium, discount, or policy for a personal articles insurance component of the dynamic product based upon the inventory or an updated inventory. Processing element 22 may then transmit the updated dynamic product to the customer for their review, approval, or modification, such as via wireless communication or data transmission with the insured's mobile device.

D. Determining Life Events

A computer system for generating or updating the dynamic product based upon life events and/or life event data may include a client device 16 or smart home controller 17 in communication with a remote computer device (e.g., a server) 14 via a network 12. The computer system may acquire life event data from, for example, a user of a client or mobile device 16 (e.g., a smart phone, a digital camera, smart watch, smart glasses, wearable electronics, laptop, smart vehicle, etc.). Alternatively, or additionally, life event data may be automatically obtained from a third party data source (e.g., a bureau of motor vehicles, a court, a country, a state, a county, a local municipality, a government agency, a utility provider, a cable company, a phone company, etc.) with the permission of the insured, such as receiving a notification from the insured that they would like to opt-in to an insurance program that automatically provides insurance savings to risk averse customers and/or recommendations based upon life events.

As described in detail herein, the computer system may automatically generate or revise the dynamic product based upon, for example, life events and/or life event data. The life events and/or life event data, may be representative, for example, a marriage, a divorce, a child birth, a name change, a vehicle purchase, a vehicle sale, a house purchase, a home sale, an adoption, a change in employment, a change in employer, a move into a new apartment or home, a move to a different state, etc.

Processing element 22 may execute a module or software application 26 (that may employ a machine learning technique) to cause the processing element 22 to automatically detect an actual life event from analysis of data received from a data source (e.g., a bureau of motor vehicles data source, a court data source, a marriage records data source, an obituaries data source, a government agency data source, etc.), such as with an insured's permission to monitor for life events that may provide them with insurance recommendations and/or insurance cost savings. Alternatively, or additionally, processing element 22 may execute a module or software application 26 (that may employ a machine learning technique) to cause the processing element 22 automatically predict a life event from data mined from at least one data source (e.g., an insurance provider data source), such as with an insured's permission to monitor for life events that may provide them with insurance recommendations and/or insurance cost savings.

The processing element 22 may execute an automatic life event data generation module to cause the processing element 22 to automatically update a risk profile or level for a component of the dynamic product or an overall risk profile for the dynamic profile. For instance, the components of the dynamic product may include homeowners, auto, life, health, and personal articles insurance components. The processing element 22 may determine a life event from applying a machine learning or other algorithm to the data collected via the network 12, and then may determine an impact of the life event on an insured, a risk profile for the insured, and/or the dynamic product. The processing element 22 may then create a new, or update an existing, dynamic product.

The processing element 22 may execute a module or software application 26 that causes the processing element 22 to automatically determine if there is at least one gap in insurance coverage for an existing insurance customer based upon the life event data. For instance, the processing element 22 may determine that there is a need for additional insurance based upon the purchase, or impending purchase, of a new vehicle, new personal articles, or a new home, or the birth of a child or a marriage.

E. Telematics Data and Auto Component

Telematics data, as used herein, may include telematics data, and/or other types of data that have not been conventionally viewed as “telematics data.” The telematics data may be generated by, and/or collected or received from, various sources. For example, the data may include, indicate, and/or relate to vehicle (and/or mobile device) speed; acceleration; braking; deceleration; turning; time; GPS (Global Positioning System) or GPS-derived location, speed, acceleration, or braking information; vehicle and/or vehicle equipment operation; external conditions (e.g., road, weather, traffic, and/or construction conditions); other vehicles or drivers in the vicinity of an accident; vehicle-to-vehicle (V2V) communications; vehicle-to-infrastructure communications; and/or image and/or audio information of the vehicle and/or insured driver before, during, and/or after an accident. The data may include other types of data, including those discussed elsewhere herein. The data may be collected via wired or wireless communication.

The data may be generated by mobile devices (smart phones, cell phones, lap tops, tablets, phablets, PDAs (Personal Digital Assistants), computers, smart watches, pagers, hand-held mobile or portable computing devices, smart glasses, smart electronic devices, wearable devices, smart contact lenses, and/or other computing devices); smart vehicles; dash or vehicle mounted systems or original telematics devices; public transportation systems; smart street signs or traffic lights; smart infrastructure, roads, or highway systems (including smart intersections, exit ramps, and/or toll booths); smart trains, buses, or planes (including those equipped with Wi-Fi or hotspot functionality); smart train or bus stations; internet sites; aerial, drone, or satellite images; third party systems or data; nodes, relays, and/or other devices capable of wireless RF (Radio Frequency) communications; and/or other devices or systems that capture image, audio, or other data and/or are configured for wired or wireless communication.

In some embodiments, the data collected may also derive from police or fire departments, hospitals, and/or emergency responder communications; police reports; municipality information; automated Freedom of Information Act requests; and/or other data collected from government agencies and officials. The data from different sources or feeds may be aggregated.

The telematics and other data generated may be transmitted, via one or more radio links, to a remote server or external computing device 14, such as a remote server and/or other processor(s) associated with an insurance provider. The remote server 14 and/or associated processors may build a database of the telematics and/or other data, and/or otherwise store the data collected.

The remote server 14 and/or associated processors may analyze the data collected, such as via a machine learning technique, and then perform certain actions and/or issue tailored communications based upon the data, including adjusting an auto insurance component of the dynamic product. The automatic gathering and collecting of data from several sources by the insurance provider, such as via one or more radio links, may prompt adjustment to auto-related risk levels or profiles, and/or an auto component within the dynamic product, and may include the automatic identification of insured events, and/or the automatic or semi-automatic processing or adjusting of insurance claims.

In one embodiment, telematics data may be collected by a mobile device (e.g., smart phone) application. An application that collects telematics data may ask an insured for permission to collect and send data about driver behavior and/or vehicle usage to a remote server 14 associated with an insurance provider. The remote server 14 may be trained to identify risk averse driving behavior, and a machine learning program running on the remote server 14 may adjust a risk factor for the insured based upon the telematics data input into the machine learning program. In return, the insurance provider may provide incentives to risk averse insureds, such as lower premiums or rates, or discounts.

The remote server 14 may analyze the collected telematics data, using a machine learning technique, to determine driver driving behavior, driving characteristics and/or driving environments. Information regarding driving characteristics may include indicators of aggressive or conservative driving, such as speed, braking (hard, soft, frequency, etc.), acceleration, lane centering, distance from other vehicles, attentiveness, distraction, fatigue, impairment, and/or use of vehicle options or equipment. Information regarding driving environments may include time, location, type of road, traffic or congestion, weather conditions, construction, and/or other relevant information regarding the operating environment of the vehicle. The driving characteristic and/or driving environment information may be classified in categories and/or scored (e.g., by determining probabilities or likelihoods of salient features). In some embodiments, machine learning techniques may be used to determine driving characteristics and/or driving environments, and then update one or more risk profiles for a driver, and/or generate an updated dynamic product for the driver—all reflective of the telematics data collected.

To determine a driving risk or driving risk score, the remote server 40 may further analyze and/or process the insured driver driving behavior data to determine insured driver driving characteristics and/or typical acuity, normal driving conditions for the insured (including road, weather, construction, and/or traffic), and/or other insured or vehicle characteristics (including vehicle maintenance records). In some embodiments, a plurality of driving risk scores may be determined, which may be associated with different driving environments, different insured drivers, and/or different vehicles. In some embodiments, the driving risk or driving risk score may also include one or more risk aversion scores indicating a general risk preference profile or level of the insured driver.

The driving risk or driving risk score of the insured may be applied to an automobile insurance component of the dynamic product at or via the remote server 14. This may include adjusting, updating, and/or generating automobile or automotive insurance component based upon the determined driving risks or driving risk scores, which may further include adjusting, updating, determining, applying, and/or implementing premiums, rates, discounts, surcharges, deductibles, limits, and/or other terms of one or more insurance policies, which terms may be related to price and/or coverage.

The driving risk or driving risk score of the insured may also be applied to one or more non-auto insurance (e.g., health, life, home owners, renters, etc.) components of the dynamic product at the remote server 14. This may include determining associations and/or correlations between the data and risk preferences and/or levels associated with one or more insurance customers and/or insured persons. For example, driving risk scores may be indicative of general risk preferences, which may further affect risk levels relating to health, life, or property insurance policies. Changes to the one or more non-automobile insurance components may cause the dynamic product to more accurately reflect the risk levels determined from the telematics and/or other data. To this end, the server 14 may weight the driving risk scores and/or other risk scores based upon the type of insurance policy to be adjusted.

F. Data Units

In one embodiment, the processing element 22, and/or machine learning techniques discussed herein, may compare time-stamped data units of data collected over time to determine certain risk factors. For instance, time-stamped data units of GPS location acquired from an individual's mobile device may be analyzed by the processing element 22 to determine where they typically sleep to determine their current residence. Their current residence may be compared with a previous residence—the previous residence being determined from historic or older time-stamped data units of their mobile device GPS location(s). If the current residence is not the same as the previous residence after a given amount of time, an adjustment to a risk profile associated with their residence, and/or to the homeowners or renter's insurance component of the dynamic product may be warranted.

Similarly, time-stamped data units of GPS location acquired from an individual's mobile device 16 via one or more radio links 19b, 19e may be analyzed by the processing element 22 to determine where they typically spend their waking hours, which may indicate a current place of employment or school. Their current employer or level of education may be compared with a previous employer or level of education determined from historic or older time-stamped data units of their mobile device GPS location(s). A change in employment or school, may indicate a change in risk for the individual, such as a change in commute or a previously undetected change in residence—which may in turn warrant a change in the dynamic product.

Additionally, time-stamped data units of images of people or animals acquired from a smart home controller 17 via one or more radio links 19a, 19e may be analyzed by the processing element 22 to determine number of people residing in the home, and a type and number of pets residing in the home as well. The current data units of resident images may be compared with previous data units of resident images to determine a change in a household members. The change in household members may indicate an adjustment to a risk profile associated with the residence or household, and/or to the homeowners or renter's insurance component of the dynamic product may be warranted.

### Exemplary Dynamically Reconfigurable Product

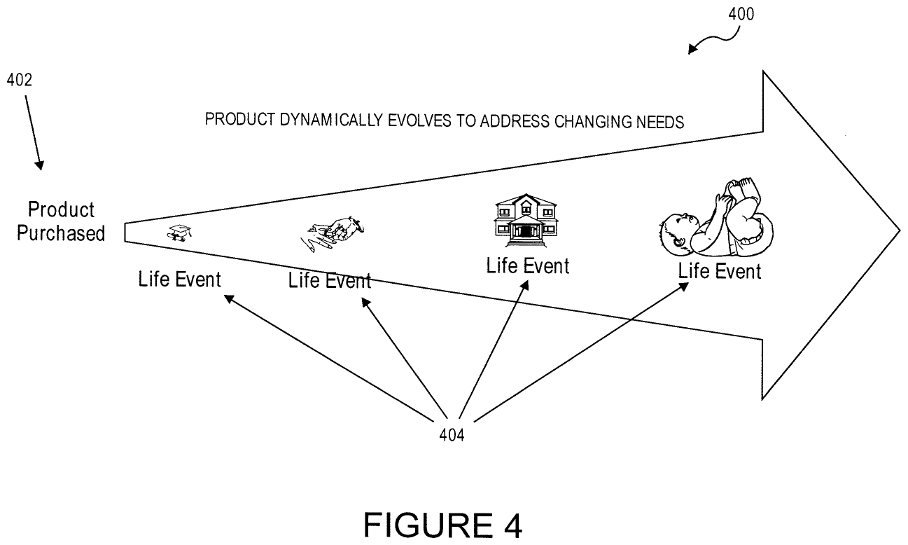

FIG. 4 illustrates an exemplary dynamically reconfigurable insurance product 400 that changes over time based upon, at least in part, computer server 14 analysis, with customer permission or affirmative consent, of customer or customer-related data, such as after customer opt-in to an insurance discount or rewards program. The dynamic product 400 may be originally purchased 402 with a single type of insurance, such as auto, and as the customer's needs change, additional types of insurance may be added—life, renters, homeowners, etc. Alternatively, the dynamic product 400 may be originally purchased 402 with more than one type of insurance, such as auto, homeowners, and life insurance to start. Still further, the dynamic product 400 may be originally purchased without definition according to traditional, discrete insurance policies. Put another way, the dynamic product 400 may comprise a need-based, comprehensive policy unbounded by the traditional outlines applicable to insurance policies. As the customer needs changes, such as at each life event 404, the coverage levels (or deductibles or limits) for each type of insurance may increase or decrease, and/or different types of insurance may be added or dropped—such as with the customer's pre-approval or post-approval.

For instance, life events 404 may include getting a driver's license; getting married or divorced; having or adopting a child; having a child get a driver's license; graduating college or high school; having a child graduate high school or college; medical events, illnesses, or surgeries; a death in the family; moving (such as moving from an apartment to a house, or vice versa); turning a certain age (e.g., 25 years old); retirement; and/or other life events. In addition to life events 404, the customer and/or customer-related data (including data generated by or received from the customer's vehicle or mobile device, and/or information gleaned from scanning social media posts (all with the customer's prior authorization or consent)) may be analyzed to determine customer activity or location, such as determining that the customer is traveling or on vacation. The different types of insurance within the dynamic product 400 may be adjusted automatically based upon the life event, customer or customer-related data, and/or activity or location of the customer. Additionally or alternatively, a proposed change to dynamic product may be communicated to the customer's mobile device via wireless communication or data transmission for their review, modification, and/or approval.

### Exemplary Adjustment Based Upon Life Event

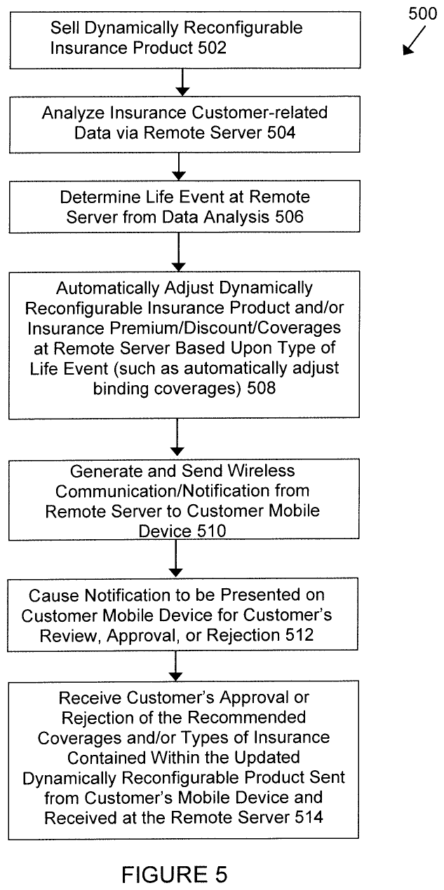

FIG. 5 illustrates an exemplary computer-implemented method 500 of adjusting a dynamically reconfigurable insurance product based upon, at least in part, customer or customer-related data, and/or life event (and/or customer activity or traveling) detection. The steps may be performed in the order shown in FIG. 5, or they may be performed in a different order. Furthermore, some steps may be performed concurrently as opposed to sequentially. In addition, some steps may be optional. The steps of the computer-implemented method 500 may be performed by the system 10.

The method 500 may include selling a dynamically reconfigurable insurance product 502; collecting and/or analyzing 504 customer-related data at or via server 14; determining or detecting a life event (or customer activity) at or via the server 14 from computer analysis of the customer-related data 504; automatically adjusting 508 the dynamically reconfigurable insurance product, scope, and/or an associated insurance premium, discount, insurance coverage, etc. at or via the server 14 based upon, at least in part, the type of life event (or customer activity or traveling); generating and transmitting 510 a communication or notification regarding the adjustment (or even a proposed adjustment) to the dynamic insurance product to the customer mobile device 18 from the server 14; causing the notification to be presented 512 on the customer's mobile device 18 for the customer's review, approval, or rejection; and/or receiving 514 a customer's approval or rejection of the changes, or recommended changes or coverages, from the customer's mobile device 18 at the server 14.

The method 500 may include selling 502 a dynamically reconfigurable insurance product. The dynamic insurance product may originally include one or more types of insurance coverage. Over time, other types of insurance coverage may be added or dropped. Also over time, coverages, limits, or deductibles associated with the different types of insurance may be adjusted, such as discussed elsewhere herein.

The method 500 may include collecting and/or analyzing 804 insurance customer or customer-related data at a server 14. Customer or customer-related data may be generated from various types of sensors, including those associated with the customer's mobile device(s) 18, home, vehicle, and/or home computer. The data may be transmitted to an insurance provider server 14 or processor via wired or wireless communication and/or data transmission from a transceiver associated with the customer's mobile device 18, home (such as a smart home controller), vehicle (such as a smart vehicle controller), and/or home computer.

The method 500 may include determining or detecting 506 a life event (and/or other customer activity) at the server 14 from computer analysis of the customer or customer-related data. For instance, from analysis of the data, it may be determined that the insured is buying or has bought a vehicle or home, is getting married, is expecting a child, is moving, is planning a trip or vacation, and/or about to experience, or has experienced, an event that has changed their insurance needs. In one embodiment, the customer or customer-related data (including mobile device, vehicle, or home-mounted sensor data and/or telematics data) may be input into a trained machine learning program to determine the life event(s) or other customer activity. Object recognition, facial recognition, and/or optical character recognition techniques may be also be applied to the data collected to determine life events or other customer activity.

The method 500 may include automatically adjusting 508 the dynamically reconfigurable insurance product and/or an associated insurance premium, discount, coverage, deductible, limit, etc. at the remote server based upon, at least in part, the type of life event (or other activity) detected. For instance, when a home is purchased, the dynamic insurance product may automatically be adjusted to include an appropriate amount of homeowners insurance for the insured, or if a new vehicle is purchased, that vehicle may be automatically insured at a recommended or appropriate level. The adjustments to the dynamically reconfigurable insurance product may be permanent and immediately binding and legally enforceable. Alternatively, the adjustments to the dynamically reconfigurable insurance product may be temporary, such as dependent upon customer review and approval.

The method 500 may include generating and transmitting 510 a communication or notification regarding the adjustment (or proposed adjustment) to the dynamic insurance product to the customer's mobile device 18 from the server 14. An insurance provider server 14 may generate a notification of changes to the dynamic insurance product, and/or proposed changes to the dynamic insurance product. The insurance provider server 14 may then transmit the notification, via wireless communication or data transmission, to the insured's mobile device 18, vehicle, home, or other computing device.

The method 500 may include causing 512 the notification to be presented on the customer's mobile device 18 for the customer's review, approval, or rejection. The notification regarding the changes or proposed changes, or other insurance recommendations, may be presented on a mobile device 18, computing device, vehicle, or home display screen for the customer's approval or rejection, for example as instructed by software application 34.

The method 500 may include receiving 514 a customer's approval or rejection of the changes, or recommended changes or coverages from the customer's mobile device 18 at the server 14. The recommendations may include adding or removing certain types of insurance to or from, respectively, the dynamic insurance product. Once the customer's approval or rejection of the changes or recommended changes to the dynamic insurance product are received at the insurance provider server 14, such as via wireless communication or data transmission from a customer's mobile device 18, vehicle, home, or other computing device, the insurance provider remote server may update the dynamic insurance product, and insurance coverages and associated billing, accordingly.

The method 500 may include additional, less, or alternate actions, including those discussed elsewhere herein, and/or may be implemented via computer system 10, communication network 12, one or more other processors or servers (e.g., other vehicle control/communication systems, mobile devices, and/or remote servers), and/or other computer-executable instructions stored on non-transitory storage media or computer readable medium.

### Exemplary Adjustment of Dynamic Product

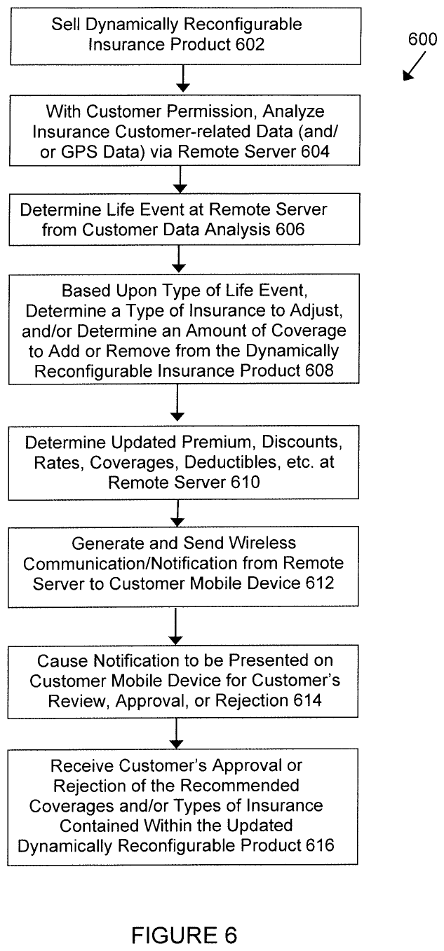

FIG. 6 illustrates an exemplary computer-implemented method 600 of determining a type of insurance to adjust within a dynamically reconfigurable insurance product having several types of insurance based upon customer data and/or life event detection. The steps may be performed in the order shown in FIG. 6, or they may be performed in a different order. Furthermore, some steps may be performed concurrently as opposed to sequentially. In addition, some steps may be optional. The steps of the computer-implemented method 600 may be performed by the system 10.

The method 600 may include selling 602 a dynamically reconfigurable insurance product (such as discussed with respect to FIG. 5 and/or elsewhere herein); with customer permission, collecting and/or analyzing 604 insurance customer or customer-related data (and/or GPS data) at server 14; determining or detecting 606 a life event (or other customer activity) at the server 14 from computer analysis of the customer or customer-related data; based upon, at least in part, the type of life event (or other customer activity) determined or detected, determining 608 a type of insurance to adjust and/or determining an amount of coverage to add or remove from the dynamically reconfigurable insurance product; determining 610 an updated or recommended premium, discount, rate, coverage, deductible, etc. at the server 14; generating and/or transmitting 612 a notification regarding the adjustment (or proposed adjustment or insurance recommendation) to the dynamic insurance product to the customer mobile device 18 from the server 14; causing 614 the notification to be presented on the customer's mobile device 18 for the customer's review, approval, or rejection; and/or receiving 616 a customer's approval or rejection of the changes, or recommended changes or coverages (and/or changes or recommended changes to the types of insurance contained with the dynamic insurance product) from the customer's mobile device 18 at the server 14.

The method 600 may include with customer permission, collecting and/or analyzing 604 insurance customer or customer-related data (and/or GPS data) at a server 14. For instance, customer data, including GPS data, may be generated by a customer mobile device 18 or vehicle, and received at insurance provider server 14, such as via wireless communication and/or data transmission.

The method 600 may include determining or detecting 606 a life event (or other customer activity) at the server 14 from computer analysis of the customer or customer-related data. The server 14 may detect life events or customer activity (such as vacations or trips, or travel movement), such as discussed elsewhere herein. In one embodiment, the customer or customer-related data (including mobile device, vehicle, or home-mounted sensor data, telematics data, and/or sensor GPS data) may be input into a trained machine learning program to determine the life event(s) or other customer activity.

The method 600 may include based upon, at least in part, the type of life event (or other customer activity) determined or detected, determining 608 a type of insurance to adjust and/or determining an amount of coverage to add or remove from the dynamically reconfigurable insurance product. For instance, if it is determined that the customer needs travel insurance and/or a reduction in auto insurance, the dynamic insurance product may be adjusted accordingly.

The method 600 may include determining 610 an updated or recommended premium, discount, rate, coverage, deductible, etc. at the server 14. For instance, as discussed elsewhere herein, the a specific portion of the dynamic insurance product premium may be scaled up or down based upon increased or decreased risk, and/or a new or reduced level of customer need.

The method 600 may include generating and/or transmitting 612 a notification regarding the adjustment (or proposed adjustment or insurance recommendation) to the dynamic insurance product to the customer mobile device 18 from the server 14. For instance, the server 14 may provide a notification to the customer mobile device 18, vehicle, home, or other computing device via wireless communication or data transmission.

The method 600 may include causing 614 the notification to be presented on the customer's mobile device 18 for the customer's review, approval, or rejection. For instance, the server 14 may cause the notification to be electronically available to the customer after the customer logs into a secure insurance provider website.

The method 600 may include receiving 616 a customer's approval or rejection of the changes, or recommended changes or coverages (and/or changes or recommended changes to the types of insurance contained with the dynamic insurance product) from the customer's mobile device 18 at the server 14. For instance, the customer's mobile device 18 may wirelessly communicate with an insurance provider's server 14 or an insurance provider's secure website.

The method 600 may include additional, less, or alternate actions, including those discussed elsewhere herein, and/or may be implemented via computer system 10, communication network 12, one or more other processors or servers (e.g., other vehicle control/communication systems, mobile devices, and/or remote servers), and/or other computer-executable instructions stored on non-transitory storage media or computer readable medium.

### Exemplary Addition to Dynamic Product

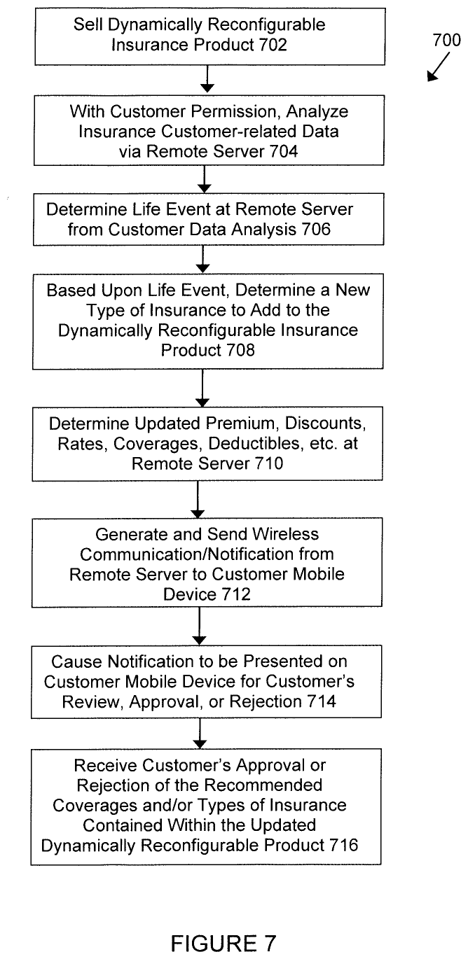

FIG. 7 illustrates an exemplary computer-implemented method 700 of determining a new type of insurance to add to a dynamically reconfigurable insurance product having several types of insurance based upon customer data and/or life event detection. The steps may be performed in the order shown in FIG. 7, or they may be performed in a different order. Furthermore, some steps may be performed concurrently as opposed to sequentially. In addition, some steps may be optional. The steps of the computer-implemented method 700 may be performed by the system 10.

The method 700 may include selling 702 a dynamically reconfigurable insurance product (such as discussed elsewhere herein); collecting and/or analyzing 704 insurance customer or customer-related data at a server 14 (such as discussed elsewhere herein); and/or determining or detecting 706 a life event (or other customer activity) at the server 14 from computer analysis of the customer-related data (such as discussed elsewhere herein). In one embodiment, the customer or customer-related data (including mobile device, vehicle, or home-mounted sensor data and/or telematics data) may be input into a trained machine learning program to determine the life event(s) or other customer activity. Object recognition, facial recognition, and/or optical character recognition techniques may be also be applied to the data collected to determine life events or other customer activity.

The method 700 may further include, based upon the life event and/or other customer activity detected, determining 708 a new type of insurance to add to the dynamically reconfigurable insurance product at the server 14; determining 710 an updated premium, discounts, rates, coverages, deductibles, etc. at the server 14; generating and transmitting 712 a communication or notification regarding the adjustment (or proposed adjustment) to the dynamic insurance product to the customer mobile device 18 from the server 14 (such as discussed elsewhere herein); causing 714 the notification to be presented on the customer's mobile device 18 for the customer's review, approval, or rejection (such as discussed elsewhere herein); and/or receiving 716 a customer's approval or rejection of the changes, or recommended changes or coverages from the customer's mobile device 18 at the server 14 (such as discussed elsewhere herein).

For instance, the method 700 may include, based upon (at least in part) the life event and/or other customer activity detected, determining 708 a new type of insurance to add to the dynamically reconfigurable insurance product at the server 14. For instance, for an insured that has bought a first vehicle, auto insurance coverage may be added to the dynamic insurance product. For an insured that bought a first house, homeowners insurance may be added. For an insured with added responsibility, such as because of a marriage or a birth of a child, life insurance may be added or increased. For an insured that has just started renting an apartment, renters insurance may be added. For an insured that has bought, or is about to buy, an expensive piece of property (an antique or engagement ring), personal articles insurance may be added or increased. For an insured that has added a pet to the family, pet insurance may be added or increased. For an insured that is traveling, temporary, or even permanent, travel insurance may be added or increased. Other types of insurance may be added to and/or removed from the dynamic insurance product, as well as increased or decreased in coverage amount.

The method 700 may include determining 710 an updated premium, discount, rate, coverage, deductible, etc. at the server 14. For instance, for the insurance types or coverage added or removed, based upon, at least in part, analysis of the customer or customer-related information, updated premiums or discounts may be calculated by the server 14, and/or applied to the dynamic insurance product.

The method 700 may include additional, less, or alternate actions, including those discussed elsewhere herein, and/or may be implemented via computer system 10, communication network 12, one or more other processors or servers (e.g., other vehicle control/communication systems, mobile devices, and/or remote servers), and/or other computer-executable instructions stored on non-transitory storage media or computer readable medium.

### Exemplary Adjustment Based Upon Location

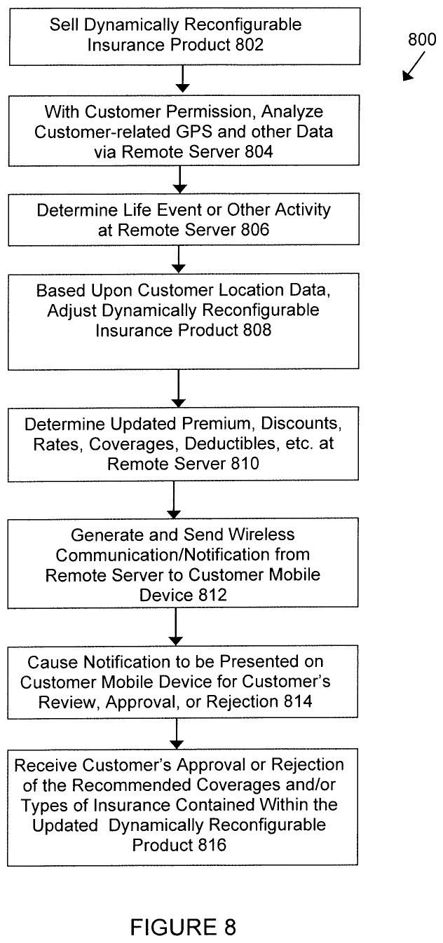

FIG. 8 illustrates an exemplary computer-implemented method 800 of adjusting a dynamically reconfigurable insurance product based upon customer location or GPS data, and determining likely activity and/or insurance needs from the customer location or GPS data (and/or life event detection). The steps may be performed in the order shown in FIG. 8, or they may be performed in a different order. Furthermore, some steps may be performed concurrently as opposed to sequentially. In addition, some steps may be optional. The steps of the computer-implemented method 800 may be performed by the system 10.

The method 800 may include selling 802 a dynamically reconfigurable insurance product (such as discussed elsewhere herein); collecting and/or analyzing 804 insurance customer or customer-related data (including GPS or location) at a server 14 (such as disclosed elsewhere herein); and/or determining or detecting 806 a life event (or customer location or other customer activity/movement) at the server 14 from computer analysis of the customer-related data (such as discussed elsewhere herein). In one embodiment, the customer or customer-related data (including mobile device, vehicle, or home-mounted sensor data and/or telematics data) may be input into a trained machine learning program to determine the life event(s) or other customer activity. Object recognition, facial recognition, and/or optical character recognition techniques may be also be applied to the data collected to determine life events or other customer activity.

The method 800 may include automatically adjusting 808 the dynamically reconfigurable insurance product and/or associated insurance premium, discount, coverages, etc. at the server 14 based upon, at least in part, the customer location data (and/or type of life event or detected customer movement); determining 810 an updated premium, discount, rate, coverage, etc. at the server 14 based upon, at least in part, the customer location data (and/or type of life event or detected customer movement); generating and transmitting 812 a communication or notification regarding the adjustment (or proposed adjustment) to the dynamic insurance product to the customer mobile device 18 from the server 14 (such as discussed elsewhere herein); causing 814 the notification to be presented on the customer's mobile device 18 for the customer's review, approval, or rejection (such as discussed elsewhere herein); and/or receiving 816 a customer's approval or rejection of the changes, or recommended changes or coverages (and/or changes or recommended changes to the types of insurance contained within the dynamic insurance product, and/or the various coverage amounts) from the customer's mobile device 18 at the server 14.

For instance, the method 800 may include automatically adjusting 808 the dynamically reconfigurable insurance product and/or associated insurance premium, discount, coverages, etc. at the server 14 based upon the customer location data (and/or type of life event or detected customer movement). The dynamic insurance product may be adjusted based upon, at least in part, customer location data, such as GPS data received from a customer mobile device 18 or vehicle. As an example, if it is determined that the customer is taking a trip and not using their personal vehicle, their auto insurance rate may be dynamically adjusted, and/or the dynamic insurance product may be automatically adjusted to include travel insurance. Other adjustments to the dynamic insurance product may also be made, including those discussed elsewhere herein.

The method 800 may include determining 810 an updated premium, discount, rate, coverage, etc. at the server 14 based upon, at least in part, the customer location data (and/or type of life event or detected customer movement). For instance, various types of insurance (auto, home, renters, life, travel, etc.) may be adjusted in real-time or near real-time based upon GPS information received from the customer's mobile device 18 or other computing device, such as discussed elsewhere herein. Other adjustments may be made based upon customer or customer device information.

The method 800 may include additional, less, or alternate actions, including those discussed elsewhere herein, and/or may be implemented via computer system 10, communication network 12, one or more other processors or servers (e.g., other vehicle control/communication systems, mobile devices, and/or remote servers), and/or other computer-executable instructions stored on non-transitory storage media or computer readable medium.

### Exemplary Adjustment of Reconfigurable Product

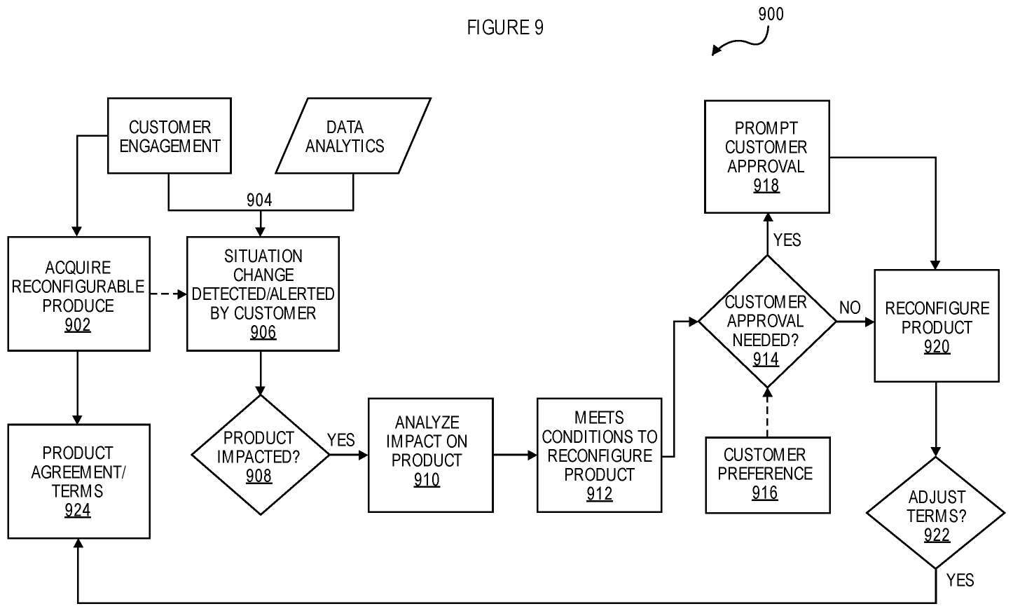

FIG. 9 illustrates an exemplary computer-implemented method 900 of reconfiguring a dynamically reconfigurable insurance product based upon customer input or engagement, customer data and/or situation change detection. The steps may be performed in the order shown in FIG. 9, or they may be performed in a different order. Furthermore, some steps may be performed concurrently as opposed to sequentially. In addition, some steps may be optional. The steps of the computer-implemented method 900 may be performed by the system 10.

The method 900 may include acquiring 902 a dynamically reconfigurable insurance product (such as discussed with respect to FIGS. 5-8 and/or elsewhere herein); receiving 904 customer input or engagement and/or the results of an analysis of customer data at server 14; with customer permission, analyzing and/or determining 906 customer input or engagement and/or the results of an analysis of customer data at server 14 to determine if a situation change has occurred (such as employing or applying machine learning, object recognition, optical character recognition, or facial recognition techniques or algorithms to the customer data); determining 908 at the server 14 whether a situation change impacts the terms of the dynamically reconfigurable insurance product; if the answer is no, halting further analysis based upon the customer input or engagement and/or results of analysis of customer data under consideration (not shown); if the answer is yes, analyzing 910 at server 14 the impact of the situation change on the dynamically reconfigurable insurance product to determine 912 whether the situation change meets the conditions for reconfiguration of the product—if not, further analysis is halted as described immediately above; if the answer to the inquiry at step 912 is yes, determining 914 whether customer approval is needed for a proposed reconfiguration determined based upon the analysis of step 912; determining 914 whether customer approval is needed may include considering a previously-entered customer preference 916; where approval is needed, generating and transmitting a notification regarding, or prompting 918 the customer to approve, the adjustment (or proposed adjustment or insurance recommendation) to the dynamic insurance product to the customer mobile device 18 from the server 14; if the customer approves pursuant to step 918 or if customer approval is not needed, reconfiguring 920 the dynamically reconfigurable product; determining 922 whether the reconfiguration requires a change or adjustment to any terms governing the dynamically reconfigurable insurance product; and updating or re-affirming the continued vitality 924 of a product agreement and/or terms associated with the dynamically reconfigurable insurance product in light of the reconfiguration at step 920.

The method 900 may include additional, less, or alternate actions, including those discussed elsewhere herein, and/or may be implemented via computer system 10, communication network 12, one or more other processors or servers (e.g., other vehicle control/communication systems, mobile devices, and/or remote servers), and/or other computer-executable instructions stored on non-transitory storage media or computer readable medium.

### Exemplary Customer-Related Data

The customer and/or customer-related data discussed herein may include data stored in an insurance provider server 14 (such as customer information—name, age, marital status, dependents, address, employment status, financial income, financial accounts, account balances (such as savings, checking, trading, credit or debit card, or mutual fund account balances), etc.), and/or dynamic data collected by a customer's mobile device 18, smart home controller, smart vehicle, various sensors or sensor arrays, and/or other customer computing device.

In one embodiment, the customer and/or customer-related data may also include telematics data, such as telematics data collected by a smart vehicle, mobile device 18 or mobile device application 34, or a conventional dashboard plug-in telematics device. The telematics data, as used herein, may include telematics data, and/or other types of data that have not been conventionally viewed as “telematics data.” The telematics data may be generated by, and/or collected or received from, various sources. For example, the data may include, indicate, and/or relate to vehicle (and/or mobile device) speed; vehicle mileage and/or vehicle usage, vehicle acceleration, braking, deceleration, turning, or corning time; GPS (Global Positioning System) or GPS-derived location, speed, acceleration, or braking information; vehicle and/or vehicle equipment operation; external conditions (e.g., road, weather, traffic, and/or construction conditions); other vehicles or drivers in the vicinity of an accident; vehicle-to-vehicle (V2V) communications; vehicle-to-infrastructure communications; and/or image and/or audio information of the vehicle and/or insured driver before, during, and/or after an accident.

The customer or customer-related data may include other types of data, including those discussed elsewhere herein. The data may be collected via wired or wireless communication with customer permission.

The customer or customer-related data may be generated by mobile devices 18 (smart phones, cell phones, lap tops, tablets, phablets, PDAs (Personal Digital Assistants), computers, smart watches, pagers, hand-held mobile or portable computing devices, smart glasses, smart electronic devices, wearable devices, smart contact lenses, and/or other computing devices); smart vehicles; dash or vehicle mounted systems or original telematics devices; public transportation systems; smart street signs or traffic lights; smart infrastructure, roads, or highway systems (including smart intersections, exit ramps, and/or toll booths); smart trains, buses, or planes (including those equipped with Wi-Fi or hotspot functionality); smart train or bus stations; internet sites; aerial, drone, or satellite images; third party systems or data; nodes, relays, and/or other devices capable of wireless RF (Radio Frequency) communications; and/or other devices or systems that capture image, audio, or other data and/or are configured for wired or wireless communication.

In some embodiments, the customer data, customer-related data, and/or telematics data collected may also derive from police or fire departments, hospitals, and/or emergency responder communications; police reports; municipality information; automated Freedom of Information Act requests; and/or other data collected from government agencies and officials, which may be obtained from databases 18 for example. The data from different sources or feeds may be aggregated.

The data generated may be transmitted, via wired or wireless communication, to a server 14, which may comprise a remote server and/or other processor(s) associated with an insurance provider. The server 14 and/or associated processors may build a database of the customer-related data, and/or otherwise store the data collected.

The server 14 and/or associated processors may analyze the data collected and then perform certain actions and/or issue tailored communications based upon the data, including the insurance-related actions or communications discussed elsewhere herein, and/or adjusting a dynamic insurance product. The automatic gathering and collecting of data from several sources by the insurance provider, such as via wired or wireless communication, may lead to expedited insurance-related activity, including the automatic identification of insured events and/or changing insurance needs for the customer, and/or the automatic or semi-automatic processing or adjusting of insurance claims.

In one embodiment, customer and/or customer-related data (including location and/or telematics data) may be collected by a mobile device (e.g., smart phone) application 34. An application 34 that collects the customer or customer-related data may ask an insured for permission to collect and send customer data, customer-related data, and/or telematics data about driver behavior and/or vehicle usage to server 14 associated with an insurance provider. In return, the insurance provider may provide incentives to the insured, such as lower premiums or rates, or discounts. The application 34 for the mobile device 18 (and/or a smart home controller or smart vehicle controller) may be downloadable off of the internet.

### Exemplary Mobile Device or Vehicle Controller

Customer and/or customer-related data, including customer location data, may be collected via a customer mobile device, smart vehicle controller (or smart vehicle), and/or smart home controller. The mobile device, smart vehicle controller, and/or smart home controller may include a processor, wireless radio frequency transmitter and/or receiver, or transceiver, clock, microphone and/or speaker, camera or video camera, sensor, memory, and/or power supply. The mobile device 18, smart vehicle controller, and/or smart home controller may include additional, fewer, or alternate components. Additionally or alternatively, the sensors and/or sensors disbursed about a vehicle (or home) and/or affixed to various components therein may include similar functionality and/or components as those of the mobile device, smart vehicle controller, or smart home controller. The mobile device may include additional, less, or alternate functionality or components, including that discussed elsewhere herein.

The transceiver may be configured for wireless communication with sensors located about the vehicle (or home), other vehicles, other mobile devices, and/or remote servers and processors, such as those located at an insurance provider location. The clock may be used to time-stamp the date and time that information is gathered or sensed by various sensors. For example, the clock may record the time and date that photographs are taken by the camera, video is captured by the camera, and/or other data is received by the mobile device, smart vehicle controller, and/or smart home controller.

The microphone and speaker may be configured for recognizing voice or audio input and/or commands. The clock may record the time and date that various sounds are collected by the microphone and speaker, such as sounds of windows breaking, air bags deploying, tires skidding, conversations or voices of passengers, music within the vehicle, rain or wind noise, and/or other sound heard within or outside of a vehicle.

The sensor may be able to record audio or visual information. The sensor may alternatively be a speed, acceleration, directional, fluid, water, moisture, temperature, fire, smoke, wind, rain, snow, hail, motion, and/or other type of sensor, and/or gyro, compass, or accelerometer.

The memory may include software applications that control the mobile device, smart vehicle controller, smart home controller, and/or a mobile device, smart vehicle controller, or smart home controller display screen configured for accepting user input. The memory may include instructions for controlling or directing the operation of vehicle equipment that may prevent, detect, and/or mitigate vehicle damage. The memory may further include instructions for controlling a smart vehicle or smart home wireless or wired network and interacting with mobile devices and remote servers (and/or a remote server associated with an insurance provider).

The power supply may be a battery or dedicated energy generator that powers the mobile device, smart vehicle controller, and/or smart home controller. The power supply may harvest energy from the vehicle environment and be partially or completely energy self-sufficient.

The smart vehicle controller may be affixed to the vehicle. Alternatively, the smart vehicle controller may be a mobile device (such as a cellular telephone, smart phone, laptop, desktop computer, tablet, phablet, netbook, personal digital assistant (PDA), smart watch, smart glasses, wearable smart technology, pager, text messaging device, hand held communications device, and/or other device capable of one-way or two-way wireless communication), and/or other type of communications device.

The present embodiments may be implemented without changes or extensions to existing communications standards. The smart vehicle controller or smart home controller may also include or comprise a relay, node, access point, Wi-Fi AP (Access Point), local node, pico-node, relay node, and/or a mobile device capable of RF (Radio Frequency) communication. The mobile device, smart home controller, and/or smart vehicle controller may include Wi-Fi, Bluetooth, GSM (Global System for Mobile communications), LTE (Long Term Evolution), CDMA (Code Division Multiple Access), UMTS (Universal Mobile Telecommunications System), and/or other types of components and functionality.

### Exemplary Computer-Implemented Methods

In one aspect, a computer-implemented method of providing and adjusting a dynamically reconfigurable insurance product covering multiple types of insurance to an insured may be provided. The method may include, such as with customer permission or affirmative consent, (1) receiving, at or via one or more processors (such as a remote server or processor associated with an insurance provider), customer-related data; (2) determining, at or via the one or more processors, a life event (or other customer activity), and/or type thereof, from computer analysis of the customer-related data, for example, by inputting the customer-related data (which may include mobile device, vehicle, or home-mounted sensor data, and telematics data) into a machine learning program (and/or object recognition, facial recognition, or optical character recognition programs) to determine life events or other customer activity; (3) adjusting, at or via the one or more processors, the dynamically reconfigurable insurance product (and/or an associated dynamic insurance product premium or discount) based upon, at least in part, the computer analysis of the customer-related data and/or life event (or other customer activity), and/or type thereof, determined; (4) generating, at or via the one or more processors, a notification of the adjustment (or recommended adjustment) to the dynamically reconfigurable insurance product, such as a wireless communication or data transmission notification; (5) transmitting, via the one or more processors or associated transceiver (such as via wireless communication or data transmission), the notification to a mobile device or other computing device of the insured for the insured's review, approval, and/or rejection; (6) receiving, via or at the one or more processors or associated transceiver (such as via wireless communication or data transmission), an approval or rejection of the adjustment (or recommended adjustment) to the dynamically reconfigurable insurance product from the mobile device or other computing device of the insured; and/or (7) adjusting or updating an insurance premium and/or discount associated with the dynamically reconfigurable insurance product, at or via the insurance provider remote server, to facilitate adjusting or otherwise providing a dynamic insurance product to the insured that reflects current or changing insurance needs of the customer.

The dynamically reconfigurable insurance product may include auto, home, and life insurance. The customer-related data may include data collected from a customer's mobile device, smart home controller, and/or smart vehicle controller. The customer-related data may include telematics data and/or information from social media.

The life event and/or customer activity determined from computer analysis of the customer-related data and/or the machine learning program may include a marriage; a birth of child; a move to a new address; a death; a purchase or sale of a house or vehicle; and/or a divorce. The life event and/or customer activity determined from computer analysis of the customer-related data may include a determination that the customer is on a trip or vacation, and as a result, coverages for auto and/or travel insurance are adjusted within the dynamically reconfigurable insurance product by the one or more processors.

The life event and/or customer activity determined from computer analysis of the customer-related data and/or the machine learning program may include a determination that the customer has purchased or sold a vehicle or home, and as a result, coverage for auto or home insurance, respectively, is adjusted within the dynamically reconfigurable insurance product by the one or more processors. The life event and/or customer activity determined from computer analysis of the customer-related data may include a determination that the customer has married or had a child (or is about to marry or have a child), and as a result, coverage for life insurance is added or increased within the dynamically reconfigurable insurance product by the one or more processors.

In another aspect, a computer-implemented method of providing and adjusting a dynamically reconfigurable insurance product covering multiple types of insurance to an insured may be provided. The method may include, first receiving customer permission or opt-in to a discount or rewards program, and then: (1) receiving, at or via one or more processors (such as a remote server or processor associated with an insurance provider), customer-related data; (2) determining, at or via the one or more processors, a life event (or other customer activity), and/or type thereof, from computer analysis of the customer-related data, for example by inputting the customer-related data (which may include mobile device, vehicle, or home-mounted sensor data, and telematics data) into a machine learning program (and/or object recognition, facial recognition, or optical character recognition programs) to determine life events or other customer activity; (3) determining, at or via the one or more processors, (i) a new type of insurance to add to the dynamically reconfigurable insurance product, and/or (ii) a coverage amount for the new type of insurance based upon, at least in part, the computer analysis of the customer-related data and/or the life event (or other customer activity), and/or type thereof, determined, or otherwise based upon the results of the machine learning program; (4) adjusting, at or via the one or more processors, a premium for the dynamically reconfigurable insurance product based upon, at least in part, the new type of insurance to be added and/or the coverage amount of the new insurance type; (5) generating, at or via the one or more processors, a notification of the adjustment (or recommended adjustment) to the dynamically reconfigurable insurance product, such as a wireless communication or data transmission notification; (6) transmitting, via the one or more processors or associated transceiver (such as via wireless communication or data transmission), the notification to a mobile device or other computing device of the insured for the insured's review, approval, and/or rejection; and/or (7) receiving, via or at the one or more processors or associated transceiver (such as via wireless communication or data transmission), an approval or rejection of the adjustment (or recommended adjustment) to the dynamically reconfigurable insurance product from the mobile device or other computing device of the insured to facilitate adding a new type of insurance to the dynamic insurance product to meet changing insurance needs of the customer.

In another aspect, a computer-implemented method of providing and adjusting a dynamically reconfigurable insurance product covering multiple types of insurance to an insured may be provided. The method may include, first receiving customer permission or opt-in to a discount or rewards program, and then: (1) receiving, at or via one or more processors (such as a remote server or processor associated with an insurance provider), customer location data (such as GPS data from a customer vehicle or mobile device); (2) determining, at or via the one or more processors, a life event (or other customer activity), and/or type thereof, from computer analysis of the customer location data, for example by inputting the customer-related data (which may include mobile device, vehicle, or home-mounted sensor data, and telematics data) into a machine learning program (and/or object recognition, facial recognition, or optical character recognition programs) to determine life events or other customer activity; (3) adjusting, at or via the one or more processors, the dynamically reconfigurable insurance product (and/or an associated dynamic insurance product premium or discount) based upon, at least in part, the computer analysis of the customer location data and/or life event (or other customer activity), and/or type thereof, determined, or based upon the results of the machine learning technique; (4) generating, at or via the one or more processors, a notification of the adjustment (or recommended adjustment) to the dynamically reconfigurable insurance product, such as a wireless communication or data transmission notification; (5) transmitting, via the one or more processors or associated transceiver (such as via wireless communication or data transmission), the notification to a mobile device or other computing device of the insured for the insured's review, approval, and/or rejection; and/or (6) receiving, via or at the one or more processors or associated transceiver (such as via wireless communication or data transmission), an approval or rejection of the adjustment (or recommended adjustment) to the dynamically reconfigurable insurance product from the mobile device or other computing device of the insured to facilitate adjusting the dynamic insurance product to meet changing insurance needs of the customer. The life event and/or customer activity determined from computer analysis of the customer location data may include a determination that the customer is on a trip or vacation, and auto and travel insurance are adjusted within the dynamically reconfigurable insurance product.

In another aspect, a computer-implemented method of providing and adjusting a dynamically reconfigurable insurance product covering multiple types of insurance to an insured may be provided. The method may include, first receiving customer permission or opt-in to a discount or rewards program, and then: (1) receiving, at or via one or more processors (such as a remote server or processor associated with an insurance provider), customer location data (such as GPS data from a customer vehicle or mobile device); (2) determining, at or via the one or more processors, customer activity, and/or type thereof (such as the customer is taking a trip or is on vacation), from computer analysis of the customer-related data, for example by inputting the customer-related data (which may include mobile device, vehicle, or home-mounted sensor data, and telematics data) into a machine learning program (and/or object recognition, facial recognition, or optical character recognition programs) to determine life events or other customer activity; (3) determining, at or via the one or more processors, (i) a new type of insurance to add to the dynamically reconfigurable insurance product, and/or (ii) a coverage amount for the new type of insurance based upon, at least in part, the computer analysis of the customer location data and/or the customer activity, and/or type thereof, determined, and/or the results or output of the machine learning program; (4) adjusting, at or via the one or more processors, a premium for the dynamically reconfigurable insurance product based upon, at least in part, the new type of insurance to be added and/or the coverage amount of the new insurance type; (5) generating, at or via the one or more processors, a notification of the adjustment (or recommended adjustment) to the dynamically reconfigurable insurance product, such as a wireless communication or data transmission notification; (6) transmitting, via the one or more processors or associated transceiver (such as via wireless communication or data transmission), the notification to a mobile device or other computing device of the insured for the insured's review, approval, and/or rejection; and/or (7) receiving, via or at the one or more processors or associated transceiver (such as via wireless communication or data transmission), an approval or rejection of the adjustment (or recommended adjustment) to the dynamically reconfigurable insurance product from the mobile device or other computing device of the insured to facilitate adding a new type of insurance to the dynamic insurance product to meet changing insurance needs of the customer. In one embodiment, the new type of insurance added to the dynamically reconfigurable insurance product may be travel insurance, and/or other types of insurance.

The foregoing methods may include additional, less, or alternate actions, including those discussed elsewhere herein, and/or may be implemented via (i) one or more local or remote processors, such as processors associated with a customer mobile device, vehicle, or home, or insurance provider remote server, and/or (ii) computer-executable instructions stored on non-transitory computer-readable media or medium.

### Exemplary Computer Systems

In one aspect, a computer system configured for providing and adjusting a dynamically reconfigurable insurance product covering multiple types of insurance to an insured may be provided. The system may include a processor (such as a remote server or processor associated with an insurance provider) configured to, after receiving customer permission or consent: (1) receive customer-related data and/or store the customer-related data received in a memory unit; (2) determine a life event (or other customer activity), and/or type thereof, from computer analysis of the customer-related data, for example by inputting the customer-related data (which may include mobile device, vehicle, or home-mounted sensor data, and telematics data) into a machine learning program (and/or object recognition, facial recognition, or optical character recognition programs) to determine life events or other customer activity; (3) adjust the dynamically reconfigurable insurance product (and/or an associated dynamic insurance product premium or discount) based upon, at least in part, the computer analysis of the customer-related data and/or life event (or other customer activity), and/or type thereof, determined, or the output of the machine learning or other program applied to the data; (4) generate a notification of the adjustment (or recommended adjustment) to the dynamically reconfigurable insurance product, such as a wireless communication or data transmission notification; (5) transmit, or direct a transceiver to transmit (such as via wireless communication or data transmission), the notification to a mobile device or other computing device of the insured for the insured's review, approval, and/or rejection; (6) receive via the transceiver (such as via wireless communication or data transmission), an approval or rejection of the adjustment (or recommended adjustment) to the dynamically reconfigurable insurance product from the mobile device or other computing device of the insured; and/or (7) adjust or update an insurance premium and/or discount associated with the dynamically reconfigurable insurance product (and store the updated insurance premium and/or discount in a memory unit for subsequent computer access) to facilitate adjusting or otherwise providing a dynamic insurance product to the insured that reflects current or changing insurance needs of the customer.

The dynamically reconfigurable insurance product may include auto, home, and life insurance, as well as other types of insurance coverage. The customer-related data may include data collected from a customer's mobile device, smart home controller, and/or smart vehicle controller. The customer-related data includes telematics data and/or information from social media.

The life event and/or customer activity determined from computer analysis of the customer-related data and/or machine learning techniques may include a marriage; a birth of child; a move to a new address; a death; a purchase or sale of a house or vehicle; and/or a divorce. The life event and/or customer activity determined from computer analysis of the customer-related data may include a determination that the customer is on a trip or vacation, and coverages for auto and/or travel insurance are adjusted within the dynamically reconfigurable insurance product by the processor.

The life event and/or customer activity determined from computer analysis of the customer-related data and/or machine learning techniques may include a determination that the customer has purchased or sold a vehicle or home, and coverage for auto or home insurance, respectively, is adjusted within the dynamically reconfigurable insurance product by the processor. The life event and/or customer activity determined from computer analysis of the customer-related data may include a determination that the customer has married or had a child (or is about to marry or have a child), and coverage for life insurance is added or increased within the dynamically reconfigurable insurance product by the processor.

In another aspect, a computer system configured to provide and adjust a dynamically reconfigurable insurance product covering multiple types of insurance to an insured may be provided. The system may include a processor (such as a remote server or processor associated with an insurance provider) configured to, after receiving customer permission: (1) receiving customer-related data and/or store the customer-related data received in a memory unit; (2) determine a life event (or other customer activity), and/or type thereof, from computer analysis of the customer-related data, for example by inputting the customer-related data (which may include mobile device, vehicle, or home-mounted sensor data, and telematics data) into a machine learning program (and/or object recognition, facial recognition, or optical character recognition programs) to determine life events or other customer activity; (3) determine (i) a new type of insurance to add to the dynamically reconfigurable insurance product, and/or (ii) a coverage amount for the new type of insurance based upon, at least in part, the computer analysis of the customer-related data and/or the life event (or other customer activity), and/or type thereof, determined, and/or results of the machine learning or other program applied to the data; (4) adjust a premium for the dynamically reconfigurable insurance product based upon, at least in part, the new type of insurance to be added and/or the coverage amount of the new insurance type; (5) generate a notification of the adjustment (or recommended adjustment) to the dynamically reconfigurable insurance product, such as a wireless communication or data transmission notification; (6) transmit, or direct a transceiver to transmit (such as via wireless communication or data transmission), the notification to a mobile device or other computing device of the insured for the insured's review, approval, and/or rejection; and/or (7) receive via the transceiver (such as via wireless communication or data transmission) an approval or rejection of the adjustment (or recommended adjustment) to the dynamically reconfigurable insurance product from the mobile device or other computing device of the insured (and/or store the updated dynamically reconfigurable insurance product in a memory unit for subsequent computer access and further updating over time) to facilitate adding a new type of insurance to the dynamic insurance product to meet changing insurance needs of the customer.

In another aspect, a computer system configured to provide and adjust a dynamically reconfigurable insurance product covering multiple types of insurance to an insured may be provided. The system may include a processor (such as a remote server or processor associated with an insurance provider) configured to, after receiving customer permission: (1) receive customer location data (such as GPS data from a customer vehicle or mobile device) and store the customer location data in a memory unit; (2) determine a life event (or other customer activity), and/or type thereof, from computer analysis of the customer location data, for example by inputting the customer-related data (which may include mobile device, vehicle, or home-mounted sensor data, and telematics data) into a machine learning program (and/or object recognition, facial recognition, or optical character recognition programs) to determine life events or other customer activity; (3) adjust the dynamically reconfigurable insurance product (and/or an associated dynamic insurance product premium or discount) based upon, at least in part, the computer analysis of the customer location data and/or life event (or other customer activity), and/or type thereof, determined, and/or output of the machine learning or other program/technique applied to the data; (4) generate a notification of the adjustment (or recommended adjustment) to the dynamically reconfigurable insurance product, such as a wireless communication or data transmission notification; (5) transmit via a transceiver (such as via wireless communication or data transmission) the notification to a mobile device or other computing device of the insured for the insured's review, approval, and/or rejection; and/or (6) receive via the transceiver (such as via wireless communication or data transmission) an approval or rejection of the adjustment (or recommended adjustment) to the dynamically reconfigurable insurance product from the mobile device or other computing device of the insured (and storing the dynamically reconfigurable insurance product in a memory unit for subsequent computer access and further refinement or updating) to facilitate adjusting the dynamic insurance product to meet changing insurance needs of the customer. In one embodiment, the life event and/or customer activity determined from computer analysis of the customer location data may include a determination that the customer is on a trip or vacation, and auto and travel insurance are adjusted within the dynamically reconfigurable insurance product.

In another aspect, a computer system configured to provide and adjust a dynamically reconfigurable insurance product covering multiple types of insurance to an insured may be provided. The system may include a processor (such as a remote server or processor associated with an insurance provider) configured to, after receiving customer permission: (1) receive customer location data (such as GPS data from a customer vehicle or mobile device) and stored the customer location data in a memory unit; (2) determine customer activity, and/or type thereof (such as the customer is taking a trip or is on vacation), from computer analysis of the customer-related data, for example by inputting the customer-related data (which may include mobile device, vehicle, or home-mounted sensor data, and telematics data) into a machine learning program (and/or object recognition, facial recognition, or optical character recognition programs) to determine life events or other customer activity; (3) determine (i) a new type of insurance to add to the dynamically reconfigurable insurance product, and/or (ii) a coverage amount for the new type of insurance based upon, at least in part, the computer analysis of the customer location data and/or the customer activity, and/or type thereof, determined, and/or output of the machine learning program; (4) adjust a premium for the dynamically reconfigurable insurance product based upon, at least in part, the new type of insurance to be added and/or the coverage amount of the new insurance type; (5) generate a notification of the adjustment (or recommended adjustment) to the dynamically reconfigurable insurance product, such as a wireless communication or data transmission notification; (6) transmit via a transceiver (such as via wireless communication or data transmission) the notification to a mobile device or other computing device of the insured for the insured's review, approval, and/or rejection; and/or (7) receive via the transceiver (such as via wireless communication or data transmission) an approval or rejection of the adjustment (or recommended adjustment) to the dynamically reconfigurable insurance product from the mobile device or other computing device of the insured (and storing the updated dynamically reconfigurable insurance product in a memory unit for subsequent computer access and further refinement) to facilitate adding a new type of insurance to the dynamic insurance product to meet changing insurance needs of the customer. In one embodiment, the new type of insurance added to the dynamically reconfigurable insurance product may be travel or other type insurance.

The foregoing computer systems may include processors, memory units, transceivers, displays, etc. The foregoing computer systems may include additional, less, or alternate functionality, including that discussed elsewhere herein.

### Exemplary Dynamically Reconfigurable Financial Product

In one aspect, the dynamically reconfigurable product may be product-agnostic—able to handle all types (and/or combinations) of products or services provided to customers that are more appropriate for each customer based upon current life events or circumstances. Thus, in addition to insurance products, the dynamically reconfigurable product or model may be applied to other types of products as well, such as financial products (including banking or loan products), home security products, and products in other industries as well. One of the key benefits for the customer is personalization of the adaptive or overall product, and one of the key benefits for the product provider is providing more appropriate and changing products to the customer based upon their current life circumstances.

The dynamically reconfigurable product discussed herein may include several insurance and financial product or services that dynamically adjust or adapt over time to customer life events or life circumstances. For instance, the product may include a bundle of insurance and financial products, such as home, life, renters, and/or auto insurance, and one or more loans, mutual funds, stock accounts, saving or checking accounts, certificates of deposit, bonds, ETF's (electronically traded funds), etc.

As an example, if a customer has a child, a college savings account may be added to the product or recommended to the customer. As another example, if a customer gets married, a joint savings or checking account may be added to the product or recommended to the customer.

The dynamically reconfigurable product may be used to offer or adjust various financial or banking products, such as offering vehicle or home loans, loan quotes, or loan refinancing. If the customer's credit score improves, interest rates on vehicle loans, home loans, student loans, or credit cards may be reduced, or associated recommendations sent to the customer for their review and approval. Or if the outstanding balance on a loan reaches a certain threshold, offers to re-finance may be sent to the customer's mobile device, or interest rates on existing products may be automatically reduced.

Additionally or alternatively, the dynamically reconfigurable product may include offering various types of other financial products, such as mutual funds, savings or college savings accounts, and/or annuities based upon life events or current customer life circumstances. As an example, upon reaching a certain age, certain mutual funds or annuities may be added to the product or otherwise recommended to the customer to help ensure that they have sufficient funds for retirement once they reach retirement age.

Moreover, the dynamically reconfigurable product may include offering upgrades to various types of smart home or smart vehicle (such as autonomous or semi-autonomous vehicle) technology that may mitigate risk to insured assets, such as insured homes or vehicles. Insurance cost savings or discounts may be offered to risk averse customers that employ such risk mitigation technologies.

In one aspect, a computer-implemented method of providing and adjusting a dynamically reconfigurable financial product may be provided. The method may include: (1) receiving with customer permission, at or via one or more processors (such as a remote server or processor associated with a financial services provider), customer-related data; (2) determining, at or via the one or more processors, a life event (or other customer activity), and/or type thereof, from computer analysis of the customer-related data, for example by inputting the customer-related data (which may include mobile device, vehicle, or home-mounted sensor data, and telematics data) into a trained machine learning program (and/or object recognition, facial recognition, or optical character recognition programs) to determine life events or other customer activity; (3) adjusting, at or via the one or more processors, the dynamically reconfigurable financial product (and/or an associated dynamic financial product discount, cost, or interest rate) based upon, at least in part, the computer analysis of the customer-related data and/or life event (or other customer activity), and/or type thereof, determined, and/or output of the trained machine learning program; (4) generating, at or via the one or more processors, a notification of the adjustment (or recommended adjustment) to the dynamically reconfigurable financial product, such as a wireless communication or data transmission notification; (5) transmitting, via the one or more processors or associated transceiver (such as via wireless communication or data transmission), the notification to a mobile device or other computing device of the customer for the customer's review, approval, and/or rejection; (6) receiving, via or at the one or more processors or associated transceiver (such as via wireless communication or data transmission), an approval or rejection of the adjustment (or recommended adjustment) to the dynamically reconfigurable financial product from the mobile device or other computing device of the customer; and/or (7) adjusting or updating a discount, cost, or interest rate associated with the dynamically reconfigurable financial product, at or via the service provider remote server, to facilitate adjusting or otherwise providing a dynamic financial product to the customer that reflects current or changing financial needs of the customer. The method may include additional, less, or alternate actions, including those discussed elsewhere herein, and/or may be implemented via one or more local or remote processors and/or via computer-executable instructions stored on non-transitory computer-readable medium or media.

For instance, the dynamically reconfigurable financial product may include a vehicle, home, or student loan, or vehicle, home, or student loan re-financing or interest rate adjustment. The customer-related data may include data collected from a customer's mobile device, smart home controller, smart vehicle controller, sensor data, and/or an online financial or credit account. The customer-related data may include telematics data and/or information from social media.

The life event and/or customer activity determined from computer analysis of the customer-related data and/or machine learning (or other techniques applied to the data) may include a marriage; a birth of child; a move to a new address; a death; a purchase or sale of a house or vehicle; a divorce; a change in income, a graduation from school, and/or other change in the customer's finances. The life event and/or customer activity determined from computer analysis of the customer-related data may include a determination that the customer's financial situation has changed or about to change, such as a change in the customer's income indicating that an additional financial product or service may be appropriate for the customer.

Additionally or alternatively, the life event and/or customer activity determined from computer analysis of the customer-related data and/or machine learning (or other techniques applied to the data) may include a determination that the customer has purchased or sold a vehicle or home, and as a result, the customer's need for a vehicle or home loan has changed, and a proposed change to the customer's vehicle or home loan(s) is adjusted within the dynamically reconfigurable financial product by the one or more processors. Further, the life event and/or customer activity determined from computer analysis of the customer-related data and/or machine learning (or other techniques applied to the data) may include a determination that the customer has married or had a child (or is about to marry or have a child), and as a result, additional financial products or services may be appropriate, such as joint checking or savings accounts, or a college savings account, and recommended to be added within the dynamically reconfigurable financial product by the one or more processors. The dynamically reconfigurable financial product may include auto, home, and life insurance, and one or more financial products (such as a vehicle loan, home loan, mutual fund, credit card account, debit card account, student loan, or checking or savings account).

In another aspect, a computer-implemented method of providing and adjusting a dynamically reconfigurable financial product covering multiple types of financial services or products to a customer may be provided. The method may include (1) receiving with customer permission or consent, at or via one or more processors (such as a remote server or processor associated with an financial services or product provider), customer-related data; (2) determining, at or via the one or more processors, a life event (or other customer activity), and/or type thereof, from computer analysis of the customer-related data, for example by inputting the customer-related data (which may include mobile device, vehicle, or home-mounted sensor data, and telematics data) into a trained machine learning program (and/or object recognition, facial recognition, or optical character recognition programs) to determine life events or other customer activity; (3) determining, at or via the one or more processors, (i) a new type of financial product or service to add to the dynamically reconfigurable financial product, and/or (ii) a size or financial amount of the new type of financial product based upon, at least in part, the computer analysis of the customer-related data and/or the life event (or other customer activity), and/or type thereof, determined, and/or output of the machine learning or other program; (4) adjusting, at or via the one or more processors, a discount, cost, or interest rate associated with the dynamically reconfigurable financial product based upon, at least in part, the new type of financial product or service to be added and/or the size of financial amount of the new financial product or service; (5) generating, at or via the one or more processors, a notification of the adjustment (or recommended adjustment) to the dynamically reconfigurable financial product, such as a wireless communication or data transmission notification; (6) transmitting, via the one or more processors or associated transceiver (such as via wireless communication or data transmission), the notification to a mobile device or other computing device of the insured for the insured's review, approval, and/or rejection; and/or (7) receiving, via or at the one or more processors or associated transceiver (such as via wireless communication or data transmission), an approval or rejection of the adjustment (or recommended adjustment) to the dynamically reconfigurable financial product from the mobile device or other computing device of the insured to facilitate adding a new type of financial product or service to the dynamically reconfigurable financial product to meet changing financial needs of the customer. The dynamically reconfigurable financial product may include auto, home, and life insurance, and one or more financial products (such as a vehicle loan, home loan, mutual fund, credit card account, debit card account, student loan, or checking or savings account). The method may include additional, less, or alternate actions, including those discussed elsewhere herein, and/or may be implemented via one or more local or remote processors and/or via computer-executable instructions stored on non-transitory computer-readable medium or media.

### Exemplary Computer-Defined Dynamic Product

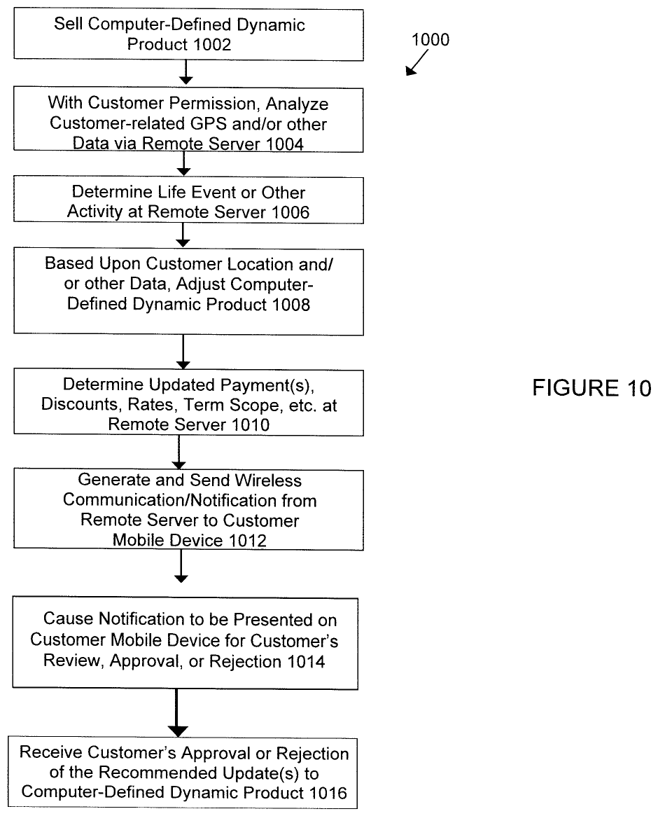

FIG. 10 illustrates an exemplary method 1000 of adjusting a computer-defined dynamic product based upon, at least in part, customer or customer-related data, and/or life event (and/or customer activity or traveling) detection. The steps may be performed in the order shown in FIG. 10, or they may be performed in a different order. Furthermore, some steps may be performed concurrently as opposed to sequentially. In addition, some steps may be optional. The steps of the computer-implemented method 1000 may be performed by the system 10.

The method 1000 may include selling a computer-defined dynamic product 1002; collecting and/or analyzing 1004 customer-related data at or via server 14; determining or detecting a life event (or customer activity) at or via the server 14 from computer analysis of the customer-related data 1004; automatically adjusting 1008 the computer-defined dynamic product, scope, and/or an associated payment schedule, discount, term scope, etc. at or via the server 14 based upon, at least in part, the type of life event (or customer activity or traveling); generating and transmitting 1010 a communication or notification regarding the adjustment/update (or even a proposed adjustment) to the computer-defined product to the customer mobile device 18 from the server 14; causing the notification to be presented 1012 on the customer's mobile device 18 for the customer's review, approval, or rejection; and/or receiving 1014 a customer's approval or rejection of the changes, or recommended changes or coverages, from the customer's mobile device 18 at the server 14.

The method 1000 may include selling 1002 a computer-defined dynamic product. The computer-defined product may originally include one or more types of insurance coverage. Over time, other types of insurance coverage may be added or dropped. Also over time, coverages, limits, or deductibles associated with the different types of insurance may be adjusted, such as discussed elsewhere herein.

However, in one aspect, the dynamically reconfigurable product may be product-agnostic—able to handle all types (and/or combinations) of products or services provided to customers that are more appropriate for each customer based upon current life events or circumstances. Thus, in addition to insurance products, the dynamically reconfigurable computer-defined product or model may be applied to other types of products as well, such as financial products (including banking or loan products), home security products, and products in other industries as well. One of the key benefits for the customer is personalization of the adaptive or overall product, and one of the key benefits for the product provider is providing more appropriate and changing products to the customer based upon their current life circumstances.

The dynamically reconfigurable product discussed herein may include several insurance and financial product or services that dynamically adjust or adapt over time to customer life events or life circumstances. For instance, the product may include a bundle of insurance and financial products, such as home, life, renters, and/or auto insurance, and one or more loans, mutual funds, stock accounts, saving or checking accounts, certificates of deposit, bonds, ETF's (electronically traded funds), etc.

As an example, if a customer has a child, a college savings account may be added to the product or recommended to the customer. As another example, if a customer gets married, a joint savings or checking account may be added to the product or recommended to the customer.

The dynamically reconfigurable computer-defined product may be used to offer or adjust various financial or banking products, such as offering vehicle or home loans, loan quotes, or loan refinancing. If the customer's credit score improves, interest rates on vehicle loans, home loans, student loans, or credit cards may be reduced, or associated recommendations sent to the customer for their review and approval. Or if the outstanding balance on a loan reaches a certain threshold, offers to re-finance may be sent to the customer's mobile device, or interest rates on existing products may be automatically reduced.

Additionally or alternatively, the dynamically reconfigurable product may include offering various types of other financial products, such as mutual funds, savings or college savings accounts, and/or annuities based upon life events or current customer life circumstances. As an example, upon reaching a certain age, certain mutual funds or annuities may be added to the product or otherwise recommended to the customer to help ensure that they have sufficient funds for retirement once they reach retirement age.

Moreover, the dynamically reconfigurable product may include offering upgrades to various types of smart home or smart vehicle (such as autonomous or semi-autonomous vehicle) technology that may mitigate risk to insured assets, such as insured homes or vehicles. Insurance cost savings or discounts may be offered to risk averse customers that employ such risk mitigation technologies.

The method 1000 may include collecting and/or analyzing 1004 customer or customer-related data at a server 14, such as with customer permission. Customer or customer-related data may be generated from various types of sensors, including those associated with the customer's mobile device(s) 18, home, vehicle, and/or home computer. The data may be transmitted to an insurance provider server 14 or processor via wired or wireless communication and/or data transmission from a transceiver associated with the customer's mobile device 18, home (such as a smart home controller), vehicle (such as a smart vehicle controller), and/or home computer.

The method 1000 may include determining or detecting 1006 a life event (and/or other customer activity) at the server 14 from computer analysis of the customer or customer-related data with customer permission, for example by inputting the customer-related data (which may include mobile device, vehicle, or home-mounted sensor data, and telematics data) into a trained machine learning program (and/or object recognition, facial recognition, or optical character recognition programs) to determine life events or other customer activity. For instance, from analysis of the data, it may be determined that the insured is buying or has bought a vehicle or home, is getting married, is expecting a child, is moving, is planning a trip or vacation, and/or about to experience, or has experienced, an event that has changed their insurance needs.

The life event and/or customer activity determined from computer analysis of the customer-related data and/or machine learning may include a marriage; a birth of child; a move to a new address; a death; a purchase or sale of a house or vehicle; a divorce; a change in income, a graduation from school, and/or other change in the customer's finances. The life event and/or customer activity determined from computer analysis of the customer-related data may include a determination that the customer's financial situation has changed or about to change, such as a change in the customer's income indicating that an additional financial product or service may be appropriate for the customer.

Additionally or alternatively, the life event and/or customer activity determined from computer analysis of the customer-related data and/or machine learning may include a determination that the customer has purchased or sold a vehicle or home, and as a result, the customer's need for a vehicle or home loan has changed, and a proposed change to the customer's vehicle or home loan(s) is adjusted within the dynamically reconfigurable financial product by the one or more processors. Further, the life event and/or customer activity determined from computer analysis of the customer-related data and/or machine learning may include a determination that the customer has married or had a child (or is about to marry or have a child), and as a result, additional financial products or services may be appropriate, such as joint checking or savings accounts, or a college savings account, and recommended to be added within the dynamically reconfigurable financial product by the one or more processors. The dynamically reconfigurable financial product may include auto, home, and life insurance, and one or more financial products (such as a vehicle loan, home loan, mutual fund, credit card account, debit card account, student loan, or checking or savings account).

The method 1000 may include automatically adjusting 1008 the computer-defined dynamic product and/or an associated insurance premium, discount, coverage, deductible, limit, etc. at the remote server based upon, at least in part, the type of life event (or other activity) detected. For instance, when a home is purchased, the computer-defined product may automatically be adjusted to include an appropriate amount of homeowners insurance for the insured, or if a new vehicle is purchased, that vehicle may be automatically insured at a recommended or appropriate level. The adjustments to the computer-defined dynamic product may be permanent and immediately binding and legally enforceable. Alternatively, the adjustments to the computer-defined dynamic product may be temporary, such as dependent upon customer review and approval.

For instance, various types of insurance (auto, home, renters, life, travel, etc.) may be adjusted in real-time or near real-time based upon GPS information received from the customer's mobile device 18 or other computing device, such as discussed elsewhere herein. Other adjustments may be made based upon customer or customer device information.

The computer-defined product may also be adjusted 1008 based upon, at least in part, customer location data, such as GPS data received from a customer mobile device 18 or vehicle. As an example, if it is determined that the customer is taking a trip and not using their personal vehicle, their auto insurance rate may be dynamically adjusted, and/or the computer-defined product may be automatically adjusted to include travel insurance. As another example, it may be determined that a geographically-sensitive computer-defined product—such as a loan for in-state tuition or home security and monitoring—may be affected by long-term or short-term location status changes, thereby prompting appropriate notifications and/or updates/changes to the computer-defined product. Other adjustments to the computer-defined product may also be made, including those discussed elsewhere herein.

The method 1000 may include generating and transmitting 1012 a communication or notification regarding the adjustment (or proposed adjustment) to the computer-defined product to the customer's mobile device 18 from the server 14. Server 14 may generate a notification of changes to the computer-defined product, and/or proposed changes to the computer-defined product. The server 14 may then transmit the notification, via wireless communication or data transmission, to the insured's mobile device 18, vehicle, home, or other computing device.

The method 1000 may include causing 1014 the notification to be presented on the customer's mobile device 18 for the customer's review, approval, or rejection. The notification regarding the changes or proposed changes, or other insurance recommendations, may be presented on a mobile device 18, computing device, vehicle, or home display screen for the customer's approval or rejection, for example as instructed by software application 34.

The method 1000 may include receiving 1016 a customer's approval or rejection of the changes, or recommended changes or coverages from the customer's mobile device 18 at the server 14. The recommendations may include adding or removing certain aspects of the computer-defined product. Once the customer's approval or rejection of the changes or recommended changes to the computer-defined product are received at the server 14, such as via wireless communication or data transmission from a customer's mobile device 18, vehicle, home, or other computing device, the server 14 may update the computer-defined product accordingly.

The method 1000 may include additional, less, or alternate actions, including those discussed elsewhere herein, and/or may be implemented via computer system 10, communication network 12, one or more other processors or servers (e.g., other vehicle control/communication systems, mobile devices, and/or remote servers), and/or other computer-executable instructions stored on non-transitory storage media or computer readable medium.

### Exemplary Machine Learning Embodiments

In one aspect, a computer-implemented method for determining an individual's overall risk profile and calculating or generating a dynamically reconfigurable insurance product may be provided. The computer-implemented method may include (1) receiving via a radio link, at one or more processors and/or transceivers, sensor data that was generated by one or more sensors positioned in and around a house (and telematics data generated by one or more vehicle or mobile device sensors); (2) generating, via the one or more processors, a data file that includes the sensor data (and telematics data) received; (3) receiving or retrieving current product data, via the one or more processors, that is derived from an existing dynamically reconfigurable insurance product, the current product data being stored in a memory unit; (4) inputting, via the one or more processors, (a) the sensor data (and/or telematics data); and (b) the current product data from the existing dynamically reconfigurable insurance product into a machine learning program to generate a resident profile that includes an indicator of an overall level of risk and/or type of risks for an individual or household; and/or (5) calculating or generating, via the one or more processors, an updated dynamically reconfigurable insurance product based upon the indicator of an overall level of risk and/or type of risks for an individual or household.

The method may include transmitting over a radio link, via the one or more processors, the updated dynamically reconfigurable insurance product to a mobile device of the individual for their review, approval, or modification. The machine learning program analyzes the data inputted to determine one or more home features, and one or more vehicle features and adjusts the overall level of risk and type of risks for the individual or household based upon the home or vehicle features determined. The machine learning program analyzes the data inputted to determine number of residents in the household, and number and types of pets in the household, and adjusts the overall level of risk and type of risks for the individual or household based upon the number of residents and number/type of pets. The method may include one or more processors generating a report that includes a listing of a plurality of events recorded by each sensor or a vehicle/mobile device. The method may include utilizing the machine learning program to determine patterns of activity from individuals within the house. The method may include utilizing the machine learning program to associate patterns of activity with particular individuals within the house.

In another aspect, a computer-implemented method for determining an individual's overall risk profile and calculating or generating a dynamically reconfigurable insurance product may be provided. The computer-implemented method may include (1) receiving via a radio link, at one or more processors and/or transceivers, (vehicle-mounted, mobile device, and/or home-mounted) sensor data that was generated by one or more sensors positioned in and around a house, vehicle, or mobile device (and telematics data generated by one or more vehicle or mobile device sensors); (2) generating, via the one or more processors, a data file that includes the sensor data (and telematics data) received; (3) receiving or retrieving current product data, via the one or more processors, that is derived from an existing dynamically reconfigurable insurance product, the current product data being stored in a memory unit; (4) inputting, via the one or more processors, (a) the sensor data (and/or telematics data); and (b) the current product data from the existing dynamically reconfigurable insurance product into a machine learning program to generate a resident profile that includes an indicator of an overall level of risk, type of risks for an individual or household, and recommended changes to insurance coverage; and/or (5) calculating or generating, via the one or more processors, an updated dynamically reconfigurable insurance product based upon the indicator of an overall level of risk and/or type of risks for an individual or household.

The methods may include additional, less, or alternate actions, including those discussed elsewhere herein. The methods may be implemented via one or more local or remote processors and transceivers, and/or via computer-executable instructions stored on computer-readable media or medium.

### Exemplary Computer Systems

In one aspect, a computer system configured to adjust a dynamically reconfigurable product of a customer may be provided. The system may include a processor configured to: (1) receive, at or via at least one transceiver over a wireless communication channel, customer-related data; (2) determine customer activity from computer analysis of the customer-related data; (3) generate an updated dynamically reconfigurable product based upon the computer analysis of the customer-related data; (4) generate an electronic notification of the updated dynamically reconfigurable product; (5) transmit, at or via the at least one transceiver over the wireless communication channel, the electronic notification to a computing device of the customer; and/or (6) receive, at or via the at least one transceiver, a response to the updated dynamically reconfigurable product from the computing device to facilitate meeting a customer's changing circumstances. The computer system may include additional, less, or alternate functionality, including the functionality mentioned elsewhere herein.

The computer analysis comprises inputting the customer-related data into a trained machine learning program executed by the processor, the trained machine learning program being trained to determine customer activity or a type of customer activity from the customer-related data. The processor may be further configured to generate a customer profile that includes (i) at least one risk type, or (ii) an overall level of risk, and the updated dynamically reconfigurable product is generated based, at least in part, on the (i) at least one risk type, or (ii) overall level of risk. The processor may be further configured to receive current product data, and the computer analysis may include inputting the current product data into the trained machine learning program.

The customer-related data may indicate one or more features of a home, and the (i) at least one risk type, or (ii) overall level of risk is generated, at least in part, based upon the one or more features of the home; and the dynamically reconfigurable product may include homeowners insurance. The customer-related data may indicate one or more features of a vehicle, and the (i) at least one risk type, or (ii) overall level of risk is generated, at least in part, based upon the one or more features of the vehicle; and the dynamically reconfigurable product may include auto insurance. The customer activity may indicate a number of residents in a residence, and the (i) at least one risk type, or (ii) overall level of risk is generated, at least in part, based upon the number of residents; and the dynamically reconfigurable product may include at least one of homeowners insurance and renters insurance.

Additionally or alternatively, the customer profile may include at least one pattern of activity associated with at least one individual, and the (i) at least one risk type, or (ii) overall level of risk is based, at least in part, on the at least one pattern of activity. The customer-related data may include personal and/or health-related information relevant to an underwriting process, and the (i) at least one risk type, or (ii) overall level of risk is generated, at least in part, based upon the computer analysis of the personal and/or health-related information; the dynamically reconfigurable product may include at least one of health insurance and life insurance; and the personal and/or health related information may include at least one of: (i) an image, (ii) a picture, (iii) a video, and (iv) an audio recording, and the processor may be further configured to apply at least one of an object recognition program, facial recognition program and an optical character recognition program to the personal and/or health related information and apply or input the result into the trained machine learning program to determine or adjust the (i) at least one risk type, or (ii) overall level of risk.

A rejection of the updated dynamically reconfigurable product may be received with a recommended change, in the response from the computing device. The processor may be further configured to apply at least one of an object recognition program, facial recognition program and an optical character recognition program to the customer-related data and input the result into the trained machine learning program, the customer-related data including sensor data collected from at least one of a home-mounted sensor, a vehicle-mounted sensor, and a customer mobile device sensor.

The processor may be further configured to generate recommended changes to the dynamically reconfigurable product, the recommended changes including at least one of (i) a new type of insurance to add to the dynamically reconfigurable product, and (ii) a coverage amount for the new type of insurance, and the processor may be further configured to adjust a premium for the dynamically reconfigurable product based upon the new type of insurance to add and the coverage amount of the new type of insurance. The customer-related data may include sensor data collected from at least one of (i) a mobile device, (ii) a smart home controller, and (iii) a smart vehicle controller; and the customer activity may include, or be associated with, a determination that the customer is on a trip or vacation, and the updated dynamically reconfigurable product may include (a) an increased auto insurance premium, (b) new or additional travel insurance, and/or (c) an adjusted premium for homeowners insurance or renters insurance.

The processor may be further configured to: prior to generating the updated dynamically reconfigurable product, transmit, at or via the at least one transceiver over one or more radio links or wireless communication channels, a prompt to the customer inquiring about a length of the trip or vacation; and receive, at or via the at least one transceiver over one or more radio links or wireless communication channels, a response from the computing device indicating the length of the trip or vacation.

The customer activity may include, or be associated with, (i) a determination that the customer has purchased a vehicle, and the updated dynamically reconfigurable product may include additional auto insurance; or (ii) a determination that the customer has purchased a home, and the updated dynamically reconfigurable product may include new or additional homeowners insurance.

The customer activity may include (i) a determination that the customer has married or had a child, and the updated dynamically reconfigurable product may include additional life insurance; or (ii) a determination that the customer has moved into an apartment, and the updated dynamically reconfigurable product may include new or additional renters insurance.

The customer activity may include a determination that the customer's finances have undergone a significant change, and the updated dynamically reconfigurable product may include a new or an additional financial product, the new or additional financial product being a vehicle loan or a home loan.

The customer activity may include a determination that the customer engages in an identified average daily commute, and the updated dynamically reconfigurable product may include an increased auto insurance premium. The dynamically reconfigurable insurance product may include at least one of auto insurance, homeowners insurance, life insurance, commercial insurance, vehicle loan, home loan, mutual fund, credit card account, debit card account, student loan, checking account and savings account. The updated dynamically reconfigurable product may include at least one of a new or an additional vehicle loan, home loan, and/or student loan; an adjusted vehicle loan interest rate, home loan interest rate, and/or student loan interest rate; and/or a re-financed student or home loan.

The customer activity determined from computer analysis of the customer-related data may include at least one of a marriage, a birth of child, a move to a new address, a death, a purchase of a house, a sale of a house, a purchase of a vehicle, a sale of a vehicle, a divorce, a change in income, a graduation from school, a significant change in the customer's finances or the customer's business or business personal property.

The customer-related data may include data automatically obtained from a third party data source with customer consent or permission, the third party source being chosen from a group consisting of: a bureau of motor vehicles database, a court records database, a national governmental records database, a state governmental records database, a county governmental records database, a local municipality records database, a government agency records database, a utility provider records database, a cable company records database, and a phone company records database.

In another aspect, a computer system configured to adjust a dynamically reconfigurable product of a customer may be provided. The system may include a processor configured to: (1) receive, at or via at least one transceiver over a wireless communication channel, customer-related data; (2) receive current product data derived from the dynamically reconfigurable product, the current product data being stored in a memory unit; (3) generate a customer profile from computer analysis of the customer-related data and the current product data, the customer profile including at least one type of risk; (4) generate an updated dynamically reconfigurable product based, at least in part, upon the customer profile; (5) generate an electronic notification (capable of wireless communication or data transmission over one or more radio links or wireless communication channels) of the updated dynamically reconfigurable product; (6) transmit, at or via the at least one transceiver over the wireless communication channel, the notification to a computing device of the customer; and/or (7) receive, at or via the at least one transceiver over the wireless communication channel, an electronic response to the updated dynamically reconfigurable product from the computing device. The computer system may include additional, less, or alternate functionality, including that discussed elsewhere herein.

For instance, the computer analysis may include inputting the customer-related data and the current product data into a trained machine learning program. The customer profile may include an overall level of risk.

The customer-related data and the current product data may indicate one or more features of a home; and the overall level of risk may be generated, at least in part, based upon the one or more features of the home, the dynamically reconfigurable product including homeowners insurance. Additionally or alternatively, the customer-related data and the current product data may indicate one or more features of a vehicle, and the overall level of risk may be generated, at least in part, based upon the one or more features of the vehicle, the dynamically reconfigurable product including auto insurance.

The customer-related data and the current product data may indicate a number of residents in a residence, and the overall level of risk may be generated, at least in part, based upon the number of residents, the dynamically reconfigurable product including at least one of homeowners insurance and renters insurance. The customer-related data and the current product data may indicate one or more features or characteristics of a business; and the overall level of risk may be generated, at least in part, based upon the one or more features or characteristics of the business, the dynamically reconfigurable product including commercial insurance.

The customer profile may include at least one pattern of activity associated with at least one individual or business entity, and wherein the at least one risk type is based, at least in part, on the at least one pattern of activity.

The customer-related data and current product data may include personal and/or health-related information relevant to an underwriting process, and the overall level of risk may be generated, at least in part, based upon the computer analysis of the personal and/or health-related information, the dynamically reconfigurable product including at least one of health insurance and life insurance. The personal and/or health related information may include at least one of: (i) an image, (ii) a picture, (iii) a video, and (iv) an audio recording, and the processor may be further configured to apply at least one of an object recognition program, facial recognition program and an optical character recognition program to the personal and/or health related information and input the result into the trained machine learning program.

The updated dynamically reconfigurable product may include at least one of (i) a new type of insurance to add to the dynamically reconfigurable product, and (ii) a coverage amount for the new type of insurance, and the processor is further configured to adjust a premium for the dynamically reconfigurable product based upon the new type of insurance and the coverage amount for the new type of insurance.

The customer-related data may include sensor data collected from at least one of (i) a mobile device, (ii) a smart home controller, and (iii) a smart vehicle controller. At least some of the sensor data may be collected from the smart home controller and the dynamically reconfigurable product may include homeowners insurance or renters insurance. The customer-related data may indicate that the customer is on a trip or vacation. The updated dynamically reconfigurable product may include an increased or decreased auto, life, or home insurance premium, and/or new or additional travel insurance.

The processor may be further configured to: prior to generating the updated dynamically reconfigurable product, transmit, at or via the at least one transceiver over the wireless communication channel or radio link, a prompt to the customer inquiring about a length of the trip or vacation; and/or receive, at or via the at least one transceiver over the wireless communication channel or radio link, a response from the computing device indicating the length of the trip or vacation.

The processor may be further configured to, prior to determining customer activity from computer analysis, train the trained machine learning program by inputting a sample data set and executing the trained machine learning program, the sample data set including at least one of: (i) an image, (ii) a picture, (iii) a video, and (iv) an audio recording. The processor may be further configured to, prior to inputting the sample data set, apply at least one of an object recognition program, facial recognition program and an optical character recognition program to the sample data set.

The updated dynamically reconfigurable product may include an increased or decreased health or life insurance premium. The customer-related data may indicate that the customer's finances have undergone a significant change, and the updated dynamically reconfigurable product may include a new or an additional financial product. The significant change may result from marriage or a child, and the new or additional financial product may be a joint financial account, a new savings account, a new college savings account, or a new whole or variable life insurance product.

In another aspect, a computer system configured to provide and adjust a dynamically reconfigurable product covering multiple types of insurance may be provided. The system may include one or more processors and transceivers configured to: (1) receive customer-related data and sensor data over one or more radio links and store the customer-related data and sensor data received in a memory unit; (2) input the customer-related data and sensor data into a machine learning program, the machine learning program being trained to determine life events from the customer-related data and sensor data; (3) determine (i) a new type of insurance to add to the dynamically reconfigurable insurance product, and (ii) a coverage amount for the new type of insurance based upon, at least in part, a life event identified; (4) adjust a premium for the dynamically reconfigurable insurance product based upon, at least in part, the new type of insurance to be added and the coverage amount of the new insurance type; (5) generate an electronic notification of the recommended adjustment to the dynamically reconfigurable insurance product; (6) transmit over a wireless communication channel the electronic notification to a mobile device or other computing device of the insured for the insured's review; and/or (7) receive over the wireless communication channel an electronic approval or rejection of the recommended adjustment to the dynamically reconfigurable product from the mobile device or other computing device of the insured to facilitate adding a new type of insurance to the dynamic product to meet changing insurance needs or circumstances of the customer. The computer system may include additional, less, or alternate functionality, including that discussed elsewhere herein.

For instance, the dynamically reconfigurable product may include auto, home, and life insurance, and one or more loan products. The customer-related data may include data collected from a customer's mobile device, smart home controller, or smart vehicle controller. The customer-related data may include telematics data or information from social media.

The life event may include, or be, a marriage; a birth of child; a move to a new address; a death; a purchase or sale of a house or vehicle; a divorce, or a purchase of a new business. The life event may include, or be associated with, a determination that the customer is on a trip or vacation, and the new type of insurance added to the dynamically reconfigurable product may be travel insurance.

The life event may include, or be associated with, a determination that the customer has purchased a vehicle, and the new type of insurance added to the dynamically reconfigurable product may be auto insurance. The life event may include, or be associated with, a determination that the customer has purchased a house, and the new type of insurance added to the dynamically reconfigurable product may be homeowners insurance. The life event may include, or be associated with, a determination that the customer has moved into an apartment, and the new type of insurance added to the dynamically reconfigurable product may be renters insurance. The life event may include, or be associated with, a determination that the customer has married or had a child, and the new type of insurance added to the dynamically reconfigurable product may be life insurance. The life event may include, or be associated with, a determination that the customer has had a child, and the new type of insurance added to the dynamically reconfigurable product may be a savings account or college savings account. The life event may include, or be associated with, a determination that the customer has added a new pet to the household, and the new type of insurance added to the dynamically reconfigurable product may be pet insurance.

The sensor data may include data collected from mobile device-mounted sensors, home-mounted sensors, vehicle-mounted sensors. The sensor data may include data collected from mobile device mounted sensors, home-mounted sensors, vehicle-mounted sensors, and the customer-related data may include data or information gathered from an internet or other wireless communication network.

In another aspect, a computer system configured to provide and adjust a dynamically reconfigurable product covering multiple types of insurance may be provided. The system may include one or more processors and transceivers configured to: (1) receive customer GPS location data and sensor data over one or more radio links, and store the customer GPS location data and sensor data in a memory unit; (2) input the customer GPS location data and sensor data into a machine learning program to trained to determine customer activity, or type thereof computer analysis of the customer GPS location data and sensor data; (3) determine (i) a new type of insurance to add to the dynamically reconfigurable product, and/or (ii) a coverage amount for the new type of insurance based upon, at least in part, the customer activity, or type thereof, determined; (4) adjust a premium for the dynamically reconfigurable product based upon, at least in part, the new type of insurance to be added and the coverage amount of the new insurance type; (5) generate an electronic notification of the recommended adjustment to the dynamically reconfigurable product; (6) transmit over one or more radio links the electronic notification to a mobile device or other computing device of the customer for the customer's review; and/or (7) receive an electronic approval or rejection of the recommended adjustment to the dynamically reconfigurable product from the mobile device or other computing device of the customer to facilitate adding a new type of insurance to the dynamic reconfigurable product to meet changing needs of the customer.

The system may include additional, less, or alternate actions, including those discussed elsewhere herein. For instance, the customer activity determined from the trained machine learning program may be that the customer is on a trip or vacation, and the new type of insurance added to the dynamically reconfigurable product may be travel insurance. The customer activity determined from the trained machine learning program may be that the customer is on a trip or vacation, and a premium for existing auto insurance for the customer may be reduced, or otherwise adjusted, to reflect non-usage of an insured vehicle.

In another aspect, a computer system configured to provide and adjust a dynamically reconfigurable product covering multiple types of insurance may be provided. The system may include one or more processors and transceivers configured to: (1) receive customer-related (and/or business-related) data and sensor data over one or more radio links and store the customer-related (and/or business-related) data and sensor data received in a memory unit; (2) input the customer-related (and/or business-related) data and sensor data into a machine learning program, the machine learning program being trained to determine customer (and/or business) activity from the customer-related (and/or business-related) data and sensor data; (3) determine (i) a new type of insurance to add to the dynamically reconfigurable insurance product, and (ii) a coverage amount for the new type of insurance based upon, at least in part, the customer (and/or business) activity identified; (4) adjust a premium for the dynamically reconfigurable insurance product based upon, at least in part, the new type of insurance to be added and the coverage amount of the new insurance type; (5) generate an electronic notification of the recommended adjustment to the dynamically reconfigurable insurance product; (6) transmit over a wireless communication channel the electronic notification to a mobile device or other computing device of the insured for the insured's review; and/or (7) receive over the wireless communication channel an electronic approval or rejection of the recommended adjustment to the dynamically reconfigurable product from the mobile device or other computing device of the insured to facilitate adding a new type of insurance to the dynamic product to meet changing insurance needs or circumstances of the customer and/or businesses. The computer system may include additional, less, or alternate functionality, including that discussed elsewhere herein.

In some embodiments, the customer activity determined from the trained machine learning program may be related to life events. Additionally or alternatively, the customer activity determined from the trained machine learning program may be related to a business, or include business activity. If the customer activity is business-related, a level of commercial property insurance coverage may be adjusted to reflect additional or less business or personal property; a level of business income insurance coverage may be adjusted to reflect increased or decreased business income; a level of crime or equipment breakdown insurance coverage may be adjusted to reflect increased or decreased risk; a level of inland marine or ocean marine insurance coverage may be adjusted to reflect increased or decreased risk; a level of workers compensation insurance coverage may be adjusted to reflect increased or decreased risk; a level of commercial general liability insurance coverage may be adjusted to reflect increased or decreased risk; a level of business or farm insurance coverage may be adjusted to reflect increased or decreased risk; and/or a level of commercial auto insurance coverage may be adjusted to reflect increased or decreased risk, or additional or fewer vehicles owned by the business. ADDITIONAL CONSIDERATIONS

With the foregoing, an insurance customer may opt into a rewards, insurance discount, or other type of program. After the insurance customer provides their affirmative consent, an insurance provider remote server may collect image data of insured assets or life events from the insurance customer's home computer, mobile device, smart vehicle, smart home, etc. For instance, data may be collected that indicates a life event, such as the purchase of new home or vehicle, birth, marriage, move, etc., such as with the insured's permission. With respect to purchasing a new home or vehicle, the data may indicate vehicle or home features, including safety or risk mitigation features. In return, risk averse drivers and/or vehicle owners (such as owners or autonomous or semi-autonomous vehicles with safety features or technology) may receive insurance discounts and/or be provided more appropriate levels of insurance coverages.

In one aspect, mobile device, smart home, or smart vehicle data, and/or the other types of data discussed elsewhere herein, may be collected or received by an insurance provider remote server, such as via direct or indirect wireless communication or data transmission from the customer's computing device, after a customer affirmatively consents or otherwise opts into an insurance discount, reward, or other program. The insurance provider may then analyze the data received with the customer's permission to provide benefits to the customer. As a result, risk averse customers may receive insurance discounts or other insurance cost savings based upon data that reflects low risk behavior and/or technology that mitigates or prevents risk to (i) insured assets, such as vehicles or homes, and/or (ii) vehicle operators or passengers, or home occupants.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

While the preferred embodiments have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

1. A computer system configured to adjust a dynamically reconfigurable product of a customer, the system including a processor configured to:
receive, at or via at least one transceiver over a wireless communication channel, customer-related data including at least one of (i) an image, (ii) a picture, (iii) a video, or (iv) an audio recording, the customer-related data including time-stamped data units of GPS location collected from at least one of a mobile device or a smart vehicle controller;
determine, based on the time-stamped data units of GPS location indicative of residence, a new residence of a customer and a driving commute from the new residence to a place of employment or school;
perform at least one of object recognition, facial recognition, or optical character recognition on the at least one of (i) an image, (ii) a picture, (iii) a video, or (iv) an audio recording, and input the result into a trained machine learning program to detect at least one customer activity, the customer activity including the driving commute and driver driving behavior, driving characteristics, and/or driving environment associated with the driving commute;
receive current product data derived from the dynamically reconfigurable product, the current product data being stored in a memory unit;
generate a customer profile from computer analysis of the customer-related data and the current product data, the customer profile including at least one type of risk based upon the customer activity;
generate an updated dynamically reconfigurable product based, at least in part, upon the customer profile;
generate an electronic notification of the updated dynamically reconfigurable product;
transmit, at or via the at least one transceiver over the wireless communication channel, the electronic notification to a computing device of the customer; and
receive, at or via the at least one transceiver over the wireless communication channel, a response, including approval, rej ection, or suggested changes, to the updated dynamically reconfigurable product from the computing device.

2. (canceled)

3. The computer system of claim 1, wherein the customer profile also includes an overall level of risk; and
the customer-related data and the current product data indicate one or more features of a home, and the overall level of risk is generated, at least in part, based upon the one or more features of the home, the dynamically reconfigurable product including homeowners insurance.

4. The computer system of claim 3, wherein the customer-related data and the current product data indicate one or more features of a vehicle, and the overall level of risk is generated, at least in part, based upon the one or more features of the vehicle, the dynamically reconfigurable product including auto insurance.

5. The computer system of claim 3, wherein the customer-related data and the current product data indicate a number of residents in a residence, and the overall level of risk is generated, at least in part, based upon the number of residents, the dynamically reconfigurable product including at least one of the homeowners insurance and renters insurance.

6. The computer system of claim 1, wherein the customer profile includes at least one pattern of activity associated with at least one individual, and wherein the at least one risk type is based, at least in part, on the at least one pattern of activity.

7. The computer system of claim 3, wherein the customer-related data and current product data include personal and/or health-related information relevant to an underwriting process, and the overall level of risk is generated, at least in part, based upon the computer analysis of the personal and/or health-related information, the dynamically reconfigurable product including at least one of health insurance and life insurance.

8. The computer system of claim 7, wherein the personal and/or health related information is comprised in at least one of: (i) the image, (ii) the picture, (iii) the video, and (iv) the audio recording.

9. The computer system of claim 1, wherein the updated dynamically reconfigurable product includes at least one of (i) a new type of insurance to add to the dynamically reconfigurable product, and (ii) a coverage amount for the new type of insurance, and the processor is further configured to adjust a premium for the dynamically reconfigurable product based upon the new type of insurance and the coverage amount for the new type of insurance.

10. The computer system of claim 1, wherein the customer-related data includes sensor data collected from at least one of (i) the mobile device, (ii) a smart home controller, and (iii) the smart vehicle controller.

11. The computer system of claim 10, wherein at least some of the sensor data is collected from the smart home controller and the dynamically reconfigurable product includes homeowners insurance or renters insurance.

12. The computer system of claim 11, wherein the customer activity indicates that the customer is on a trip or vacation.

13. The computer system of claim 12, wherein the updated dynamically reconfigurable product includes an increased auto insurance premium.

14. The computer system of claim 13, wherein the updated dynamically reconfigurable product includes additional travel insurance.

15. The computer system of claim 14, wherein the processor is further configured to:
prior to generating the updated dynamically reconfigurable product, transmit, at or via the at least one transceiver over the wireless communication channel, a prompt to the customer inquiring about a length of the trip or vacation; and
receive, at or via the at least one transceiver over the wireless communication channel, a response from the computing device indicating the length of the trip or vacation.

16. The computer system of claim 1, wherein the processor is further configured to, prior to determining the customer activity, train the trained machine learning program by inputting a sample data set and executing the trained machine learning program, the sample data set including at least one of: (i) an image, (ii) a picture, (iii) a video, and (iv) an audiorecording.

17. The computer system of claim 16, wherein the processor is further configured to, prior to inputting the sample data set, apply at least one of an object recognition program, facial recognition program and an optical character recognition program to the sample data set.

18. The computer system of claim 17, wherein the updated dynamically reconfigurable product includes an increased health insurance premium.

19. The computer system of claim 1, wherein the customer-related data indicates that the customer's finances have undergone a significant change, and the updated dynamically reconfigurable product includes an additional financial product.

20. The computer system of claim 19, wherein the significant change results from marriage or a child, and the additional financial product is a new savings account.
